(19) United States
(12) Patent Application Publication
(10) Pub. No.: US 2004/0105971 A1
(43) Pub. Date: Jun. 3, 2004

(54) Polymer processing of a substantially water-resistant microporous substrate

(76) Inventors: Luciano M. Parrinello, Allison Park, PA (US); Randall D. Rogers, Apollo, PA (US); Charles T. Hill, New Brighton, PA (US); Larry E. Lipko, North Irwin, PA (US); Paul L. Benenati, Wadsworth, OH (US); Peter M. Nowakowski, Gibsonia, PA (US); Joseph P. Kovacs, The Woodlands, TX (US)

Correspondence Address: PPG Industries, Inc., Law-Intellectual Property 39 SW, One PPGPlace, Pittsburgh, PA, 15272, US

(21) Appl. No.: 10/654,119

(22) Filed: Sep. 3, 2003

Related U.S. Application Data
(63) Continuation-in-part of application No. 10/319,326, filed on Dec. 13, 2002.
Application No. 10/319,326 is a continuation-in-part of application No. 10/231,305, filed on Aug. 30, 2002.
(60) Provisional application No. 60/317,113, filed on Sep. 5, 2001.

(51) Int. Cl. B32B 3/26

(52) U.S. Cl. 428/317.9; 428/319.3; 428/319.7

(57) ABSTRACT

The present invention is directed to a multilayer article comprising a substantially water-resistant, coated, microporous substrate connected to a substantially nonporous material. Further, the present invention is directed to a process for producing the multilayer article. The multilayer article and method of the present invention is especially useful for an ink jet recordable substrate and printing on said substrate.

This application is a continuation-in-part application of U.S. patent application Ser. No. 10/319,326 filed on Dec. 13, 2002, which is a continuation-in-part application of U.S. patent application Ser. No. 10/231,305 filed on Aug. 30, 2002, which is a conversion of U.S. Provisional Patent Application Serial No. 60/317,113 filed on Sep. 5, 2001.

The present invention is directed to a multilayer article comprising a substantially water-resistant, coated, microporous substrate connected to a substantially nonporous material. Further, the present invention is directed to a process for producing the multilayer article.

Unless otherwise indicated, all numbers or expressions referring to quantities of ingredients, reaction conditions, etc. used herein are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

The present invention is directed to a multilayer article comprising a microporous substrate at least partially connected to a substantially nonporous material, said microporous substrate at least partially coated with a substantially water-resistant coating composition, said coating composition comprising a stable dispersion of:

(a) an aqueous polyurethane dispersion; and

(b) a cationic nitrogen-containing polymeric dye fixative material at least partially dissolved in an aqueous medium.

Suitable microporous substrates for use in the present invention include microporous substrates known in the art such as cellulosic-based paper. Further, the following United States patents describe suitable microporous substrates for use in the present invention: U.S. Pat. Nos. 4,861,644; 4,892,779; and 5,196,262. Moreover, United States Patent Application having Serial No. 60/309,348 having a file date of Aug. 1, 2001, which is pending in the Patent Office describes a suitable microporous substrate for use in the present invention. The aforementioned patents and patent application are herein incorporated by reference.

In an embodiment, the microporous substrate, having a top surface and a bottom, comprises:

(a) a polyolefin;

(b) a particulate silica material; and

(c) a porosity wherein pores constitute at least 35 percent by volume of the microporous substrate.

The polyolefin for use in the microporous substrate of the present invention can include a polyolefin known in the art such as polyethylene or polypropylene. In one non-limiting embodiment, the polyethylene is an essentially linear high molecular weight polyethylene having an intrinsic viscosity of at least 10 deciliters/gram, and the polypropylene is an essentially linear high molecular weight polypropylene having an intrinsic viscosity of at least 5 deciliters/gram. As used herein and the claims “high molecular weight” refers to a weight average molecular weight of from 20,000 to 2,000,000.

As recorded herein and in the claims, intrinsic viscosity is determined by extrapolating to zero concentration the reduced viscosities or the inherent viscosities of several dilute solutions of the polyolefin wherein the solvent is distilled decahydronaphthalene to which 0.2 percent by weight, 3,5-di-tert-butyl-4-hydroxyhydrocinnamic acid, neopentanetetrayl ester [CAS Registry No. 6683-19-8] has been added. The reduced viscosities or the inherent viscosities of the polyolefin are ascertained from relative viscosities obtained at 135° C. using an Ubbelohde No. 1 viscometer in accordance with the general procedures of ASTM D 4020-81, except that several dilute solutions of differing concentration are employed. ASTM D 4020-81 is incorporated herein by reference.

The particulate silica material used in the present invention can be selected from a wide variety of known materials. Suitable non-limiting examples include silica, mica, montmorillonite, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. Silica and clays are commonly used. In one non-limiting embodiment, precipitated silica, silica gel, or fumed silica is used. In another one non-limiting embodiment, precipitated silica is used.

In general, silica can be prepared by combining an aqueous solution of a soluble metal silicate with an acid. The soluble metal silicate is typically an alkali metal silicate such as sodium or potassium silicate. The acid can be selected from the group consisting of mineral acids, organic acids, and carbon dioxide. The silicate/acid slurry can then be aged. An acid or base is added to the silicate/acid slurry. The resultant silica particles are separated from the liquid portion of the mixture. The separated silica is washed with water, the wet silica product is dried, and then the dried silica is separated from residues of other reaction products, using conventional washing, drying and separating methods.

Silica prepared by the above-described process can be a particulate material in the form of aggregates. These aggregates are composed of substantially solid, substantially spherical particles which are know in the art as primary or ultimate particles. In an embodiment, the primary or ultimate particles can have a particle size of less than 0.1 micron as measured by a laser analyzer such as a Beckman Coulter LS 230. Methods for characterizing primary particles have been described in prior art references (e.g., “The Chemistry of Silica,” Ralph K. Iler, 1979 John Wiley & Sons, New York, Chapter 5). It is known in the art that primary or ultimate particles having a particle size of less than 0.1 micron show a tendency to group together and form covalent siloxane bonds between the particles, in addition to the siloxane bonds within the primary particles. These primary or ultimate particles collect and group together to form reinforced covalently bonded structures referred to as aggregates. In the silica for use in the present invention, the aggregates have a particle size of from 0.1 to 1 micron as measured by the aforementioned Beckman Coulter LS 230. The aggregates collect and group together to form a loose agglomerate structure having an open porosity

In the present invention, at least 90 percent by weight of the silica particles used in preparing the microporous substrate have particle sizes in the range of from 5 to 40 micrometers. The particle size is determined by use of a Model Tall Coulter Multisizer Particle Size Analyzer (Coulter Electronics, Inc.) according to ASTM C 690-80, but modified by stirring the filler for 10 minutes in Isoton II electrolyte solution (Curtin Matheson Scientific, Inc.) using a four-blade, 4.445 centimeter diameter propeller stirrer. In one non-limiting embodiment, at least 90 percent by weight of the silica particles have particle sizes in the range of from 10 to 30 micrometers.

U.S. Pat. Nos. 2,940,830 and 4,681,750; and U.S. patent application having Ser. No. 09/882,549 which was filed on Jul. 14, 2001 and is pending, describe suitable precipitated silica for use in the present invention and methods for its production.

In one non-limiting embodiment, the silica particles are finely-divided. As used herein and in the claims, “finely-divided” refers to a maximum retention of 0.01% by weight on a 40 mesh sieve screen.

In one non-limiting embodiment, the silica particles are substantially insoluble. As used herein and in the claims, the term “substantially insoluble” refers to solubility in water which can range from 70 ppm to greater than 150 ppm in water at a temperature of 25° C. It is believed that variations in solubility are due to differences in particle size, state of internal hydration and the presence of trace impurities in the silica or absorbed on its surface. The solubility of the silica can also be dependent on the pH of the water. As pH increases from neutrality (i.e., pH of 7) to alkalinity (i.e., pH greater than 9), the solubility of silica can increase. (See “The Chemistry of Silica”, R. K. Iler, Wiley-Interscience, NY (1979), pp. 40-58.)

In one non-limiting embodiment, the silica particles for use in the present invention are coated prior to incorporation into the microporous substrate. U.S. patent applications having Ser. Nos. 09/636,711; 09/636,312; 09/636,310; 09/636,308; 09/636,311; and 10/041,114; disclose suitable coating compositions and methods of coating silica particles which can be used in the present invention, and which are incorporated herein by reference. The coating can be applied by a method known in the art. The selection of the method of coating the silica particles is not critical. For example, the coating ingredients can be added to an aqueous slurry of pre-washed silica filter cake under sufficient stirring to allow for complete mixing of the ingredients, followed by drying, using conventional techniques known in the art.

The particulate silica material constitutes from 50 to 90 percent by weight of the microporous substrate. In one non-limiting embodiment, the particulate silica material constitutes from 50 to 85 percent, or from 60 to 80 percent by weight of the microporous substrate.

The microporous substrate for use in the present invention has a porosity such that the pores constitute at least 35 percent by volume of the microporous substrate. As used herein and the claims, the term “pore(s)” refers to a minute opening(s) through which matter passes. In many instances, the pores constitute at least 60 percent by volume of the microporous substrate. Often, the pores constitute from 35 percent to 95 percent by volume of the microporous substrate. In one non-limiting embodiment, the pores constitute from 60 percent to 75 percent by volume.

In one non-limiting embodiment of the invention, the substrate is highly porous. The term “highly porous” refers to a substrate having a porosity of not more than 20,000, or not more than 10,000 and in many cases not more than 7,500 seconds/100 cc air. The porosity is typically at least 50 seconds/100 cc air. These porosity values are determined in accordance with the method described in ASTM D726, with the following exceptions relative to Section 8 of the ASTM. In the present invention, the sheet samples are tested without conditioning in accordance with ASTM D685, and only three (3) specimens for a given sample type are tested for a total of six (6) measurements (three measurements per two surfaces) for a given specimen type rather than a minimum of ten specimens for a given samples as stated in ASTM D726. The lower the value in seconds/cc air, the more porous is the substrate.

Highly porous substrates can be produced by various methods known in the art, such as thermally treating a substrate, orienting, compositionally by increasing the silica content, microvoiding films, or etching. Examples of highly porous substrates include thermally treated microporous materials such as Teslin TS-1000 which is commercially available from PPG Industries, Inc., Pittsburgh, Pa.

In addition to the particulate silica materials, substantially water-insoluble non-particulate silica materials can also be used in the microporous substrate. Examples of such optional non-silica particles include particles of titanium oxide, iron oxide, copper oxide, zinc oxide, antimony oxide, zirconia, magnesia, alumina, molybdenum disulfide, zinc sulfide, barium sulfate, strontium sulfate, calcium carbonate, magnesium carbonate, magnesium hydroxide, and finely divided substantially water-insoluble flame retardant particles such as particles of ethylenebis(tetra-bromophthalimide), octabromodiphenyl oxide, decabromodiphenyl oxide, and ethylenebisdibromonorbornane dicarboximide.

The microporous substrate for use in the present invention can be coated with a substantially water-resistant coating composition. In one non-limiting embodiment, at least one side of the microporous substrate is coated with a substantially water-resistant composition. An example of a suitable coating composition for use in the present invention comprises a stable dispersion of an aqueous polyurethane dispersion, and a cationic nitrogen-containing polymeric dye fixative material which is at least partially dissolved in an aqueous medium. Suitable aqueous polyurethane dispersions include known water-dispersible nonionic polyurethanes, anionic polyurethanes, cationic polyurethanes, and mixtures thereof. Polyurethane dispersions and their preparation are known in the are; for example, Szycher (i.e., “Szycher's Book of Polyurethanes” by Michael Szycher, CRC Press, New York, N.Y., 1999, Section 14) describes the preparation of water dispersions of various polyurethanes.

The addition of an aqueous solution of a cationic nitrogen-containing polymer to an aqueous anionic polyurethane dispersion results in a stable dispersion which is useful as a coating composition for an microporous substrate. However, a reversal in the order of addition such that the anionic polyurethane dispersion is added to the aqueous solution of a cationic nitrogen-containing polymer, can result in the formation and precipitation of a polysalt from the aqueous solution, if sufficient mixing is not employed.

In one non-limiting embodiment, an aqueous dispersion of an anionic polyurethane resin for use in the invention comprises particles of an anionic polyurethane polymer dispersed in an aqueous medium. The polyurethane polymer has at least one pendent acid group which can be neutralized in the presence of a base to form anionic group(s), which stabilize the dispersion.

The anionic polyurethane for use in the invention can be prepared by a method known in the art. For example, the reaction of (i) a polyisocyanate, (ii) a polyol, (iii) a compound having an acid group, and optionally (iv) a chain-extending compound such as a polyamine or hydrazine, produces a suitable anionic polyurethane. As used herein and the claims, “polyisocyanate” refers to a compound having more than one isocyanate group. Examples of suitable polyisocyanates for use in the present invention include diisocyanates such as toluene diisocyanate, hexamethylene diisocyanate, isophorone diisocyanate and dicyclohexyl methane diisocyanate; three or more functional isocyanates which can be the reaction products of diisocyanates with polyols such as trimethylol propane, glycerol and pentaerythritol. Suitable polyisocyanates for use in the invention are commercially available from Bayer Corporation under the tradename Desmodur.

As used herein and the claims, “polyol” refers to a compound with more than one hydroxyl group. Non-limiting examples of suitable polyols are simple polyols such as those used to prepare polyisocyanate, polyester polyols and polyether polyols.

The anionic polyurethane for use in the present invention can include an acid group such as a carboxylic acid or sulfonic acid group and two groups, which can react with either a polyisocyanate or a polyol. An non-limiting example of a group, which can react with a polyol, is an isocyanate group. Non-limiting examples of groups which can react with a polyisocyanate include hydroxyl groups and amine groups. An example of a compound having two hydroxyl groups and an acid group is dimethylol proprionic acid. An example of a polyamine includes ethylene diamine, isophorone diamine or diethylene triamine.

In one non-limiting embodiment, the anionic polyurethane dispersion for use in the invention can be dispersed using a base which ionizes the acidic group(s) on the polymer and stabilizes the dispersion. The base can include any known inorganic base, ammonia or an amine.

The (i) polyisocyanate, (ii) the compound having an acid group, and (iii) the polyol can be reacted in the presence of an organic solvent to form an isocyante-terminated prepolymer. Suitable organic solvents include n-methyl pyrrolidone, tetrahydrofuran or a glycol ether. The isocyanate-terminated prepolymer can be dispersed in water in the presence of a base, and then chain extended by adding the polyamine. In one non-limiting embodiment, the prepolymer is chain extended in an organic solvent solution and then the polyurethane polymer is dispersed in water in the presence of the base.

Non-limiting examples of suitable anionic polyurethanes for use in the present invention include anionic polyurethanes based on aromatic polyether polyurethanes, aliphatic polyether polyurethanes, aromatic polyester polyurethanes, aliphatic polyester polyurethanes, aromatic polycaprolactam polyurethanes, and/or aliphatic polycaprolactam polyurethanes. An anionic polyurethane dispersion for use in the present invention is commercially available from Crompton Corporation under the tradename WitcoBond®.

The aqueous anionic polyurethane dispersion of the coating composition contains up to 70 wt. %, or up to 65 wt. %, or up to 60 wt. %, or up to 50 wt. % of the anionic polyurethane. The aqueous anionic polyurethane dispersion includes at least 1 wt. %, or at least 5 wt. %, or at least 10 wt. %, or at least 20 wt. % of the anionic polyurethane. The amount of anionic polyurethane in the aqueous anionic polyurethane dispersion is not critical. In general, the amount should not be so high as to cause the dispersion itself or the mixture with the nitrogen-containing polymer to be unstable, or so low that the coating composition does not provide sufficient water and rub resistance or that the dispersion itself becomes unstable. The anionic polyurethane can be present in the aqueous anionic polyurethane dispersion in any range of values inclusive of those stated above.

A variety of known water-dispersible cation polyurethanes can be used as the cationic polyurethane dispersion in the embodiments of the present invention. Suitable non-limiting examples of cationic polyurethanes are available commercially from Crompton Corporation under the tradename Witcobond, for example, Witcobond W-213 and W-215 formulations.

The cationic polyurethane can be prepared by methods known in the art. U.S. Pat. No. 3,470,310 discloses the preparation of a water dispersion of polyurethane which contains salt-type groups connected into the polyurethane. U.S. Pat. No. 3,873,484 discloses an aqueous dispersion of polyurethane prepared from quaternized polyurethane prepolymer prepared by reacting an alkoxylated diol, an N-alkyl dialkanolamine, an organic diisocyanate and quaternizing with a dialkyl sulfate quaternizing agent. U.S. Pat. No. 6,221,954 teaches a method for making a polyurethane prepolymer in which a N-monoalkanol tertiary amine is reacted with an alkylene oxide in the presence of a strong acid to form a polyol salt, which is further reacted with an excess amount of an organic polyisocyanate and chain extended with an active hydrogen-containing compound. These references are herein incorporated by reference.

In one non-limiting embodiment, the aqueous cationic polyurethane dispersion for use in the present invention can contain up to 70 wt. %, or up to 65 wt. %, or up to 60 wt. %, or up to 50 wt. % of the cationic polyurethane. In alternate non-limiting embodiments, the aqueous cationic polyurethane dispersion includes at least 1 wt. %, or at least 5 wt. %, or at least 10 wt. %, or at least 20 wt. % of the cationic polyurethane. The amount of cationic polyurethane in the aqueous cationic polyurethane dispersion is not critical. In general, the amount should not be so high as to cause the dispersion itself or the mixture with the nitrogen-containing polymer to be unstable, or so low that the coating composition does not provide sufficient water and rub resistance or that the dispersion itself becomes unstable. The cationic polyurethane can be present in the aqueous cationic polyurethane dispersion in any range of values inclusive of those stated above.

Any known water-dispersible non-ionic polyurethane can be used as the nonionic polyurethane dispersion for use in the present invention. Non-limiting examples of suitable cationic polyurethanes are available commercially from Crompton Corporation under the tradename Witcobond, for example, Witcobond W-230 formulation.

The nonionic polyurethane can be prepared by a method known in the art. For example, Szycher (i.e., “Szycher's Book of Polyurethanes” by Michael Szycher, CRC Press, New York, N.Y., 1999, pages 14-10 through 14-15) describes the preparation of water dispersions of polyurethanes, which contain hydrophilic polyether-type groups either branching off or terminating on the main polyurethane chains. Polyethylene oxide units (having a molecular weight (MW) of from 200 to 4,000) are typically used as dispersing sites. Nonionic polyurethanes can be prepared by the use of diols or diisocyanate comonomers bearing pendant polyethylene oxide chains.

In alternate non-limiting embodiments of the present invention, the aqueous nonionic polyurethane dispersion can contain up to 70 wt. %, or up to 65 wt. %, or up to 60 wt. %, or up to 50 wt. % of the nonionic polyurethane. The aqueous nonionic polyurethane dispersion includes at least 1 wt. %, or at least 5 wt. %, or at least 10 wt. %, or at least 20 wt. % of the nonionic polyurethane. The amount of nonionic polyurethane in the aqueous nonionic polyurethane dispersion is not critical. In general, the amount should not be so high as to cause the dispersion itself or the mixture with the nitrogen-containing polymer to be unstable, or so low that the coating composition does not provide sufficient water and rub resistance or that the dispersion itself becomes unstable. The nonionic polyurethane can be present in the aqueous nonionic polyurethane dispersion in any range of values inclusive of those stated above.

In a non-limiting embodiment of the present invention, the cationic nitrogen-containing polymeric dye fixative material which is at least partislly dissolved in an aqueous medium, has a pH of less than 7, or less than 6, or less than 5. A pH value within this range allows for at least a portion of the nitrogen atoms to carry at least a portion of a cationic charge. The resulting coating composition will have a pH of less than 7, or less than 6, or less than 5.

A dye fixative is generally used to at least partially fix dyes to a substrate to preclude the dyes from bleeding or migrating out of the substrate when the substrate is contacted with water.

A variety of known cationic nitrogen-containing polymers within the above-mentioned pH range of the coating composition, can be used in the present coating composition as a dye fixative. Non-limiting examples of suitable cationic nitrogen-containing polymers include cationic polymers having one or more monomer residues derived from one or more of the following nitrogen-containing monomers:

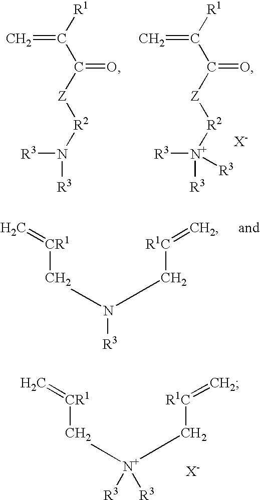

where R¹ represents independently for each occurrence in each structure, H or C₁ to C₃ aliphatic; R² represents independently for each structure a divalent linking group selected from C₂ to C₂₀ aliphatic hydrocarbon, polyethylene glycol and polypropylene glycol; R³ represents independently for each occurrence in each structure H, C₁ to C₂₂ aliphatic hydrocarbon or a residue from the reaction of the nitrogen with epichlorohydrin; Z is selected from —O— or —NR⁴—, where R⁴ is H or CH₃; and X is a halide or methylsulfate.

Non-limiting examples of nitrogen-containing monomers used to prepare polymeric dye fixative materials of the present invention containing the corresponding monomer residue or resulting monomer residues include dimethyl aminoethyl (meth)acrylate, (meth)acryloyloxyethyl trimethyl ammonium halides, (meth)acryloyloxyethyl trimethyl ammonium methylsulfate, dimethyl aminopropyl (meth)acrylamide, (meth)acrylamidopropyl trimethyl ammonium halides, aminoalkyl (meth)acrylamides where the amine is reacted with epichlorohydrin, (meth)acrylamidopropyl trimethyl ammonium methylsulfate, diallyl amine, methyl diallyl amine, and diallyl dimethyl ammonium halides.

In alternate non-limiting embodiments, additional monomers can also be used in preparing the cationic nitrogen-containing polymers containing the corresponding monomer residue. The additional monomer residues can be obtained from any polymerizable ethylenically unsaturated monomer that, when copolymerized with the nitrogen-containing monomers is adapted to provide a the resulting polymer that is at least partially soluble in water. As used herein and the claims, “partially soluble” refers to at least 0.1 gram of the polymer dissolving in deionized water when ten (10) grams of the polymer is added to one (1) liter of water and sufficiently mixed for 24 hours.

Non-limiting examples of monomers that can be copolymerized with the nitrogen-containing monomers include (meth)acrylamide, n-alkyl (meth)acrylamides, (meth)acrylic acid, alkyl esters of (meth)acrylate, glycol esters of (meth)acrylic acid, polyethylene glycol esters of (meth)acrylic acid, hdroxyalkyl (meth)acrylates, itaconic acid, alkyl ethers of itaconic acid, maleic acid, mono- and di-alkyl esters of maleic acid, maleic anhydride, maleimide, aconitic acid, alkyl esters of aconitic acid, allyl alcohol and alkyl ethers of allyl alcohol.

In one non-limiting embodiment, the cationic nitrogen-containing polymer is a homopolymer of a nitrogen-containing monomer, or a copolymer of one or more nitrogen-containing monomers. In another one non-limiting embodiment, the nitrogen-containing polymer is a copolymer of one or more polymerizable ethylenically unsaturated monomers and one or more nitrogen containing monomers. In alternate non-limiting embodiments, when the nitrogen-containing polymer includes any of the aforementioned additional polymerizable ethylenically unsaturated comonomers, the nitrogen-containing polymer can include not more than 70 mol %, or not more than 50 mol %, or not more than 25 mol %, or not more than 10 mol % of the nitrogen-containing monomer. The amount of nitrogen-containing monomer can be dependent upon the specific polyurethane used in the present coating composition. When the amount of the nitrogen-containing monomer used in the nitrogen-containing polymer is too high, an unstable mixture of the nitrogen-containing polymer and polyurethane dispersion can result.

In alternate non-limiting embodiments, when the nitrogen-containing polymer includes any of the aforementioned additional polymerizable ethylenically unsaturated comonomers, the nitrogen-containing polymer can include at least 0.1 mol %, or at least 1.0 mol %, or at least 2.5 mol %, or at least 5.0 mol % of the nitrogen-containing monomer. When the amount of nitrogen-containing monomer in the nitrogen-containing polymer is too low (i.e., less than 0.1 mol %), the nitrogen-containing polymer cannot provide adequate dye fixative properties and a recorded ink image on the coated substrate can lack water and rub fastness properties.

The nitrogen-containing monomers can be present in the nitrogen-containing polymer in any range of values inclusive of those stated above. The additional polymerizable ethylenically unsaturated monomers will be present in an amount such that the total percentage is 100 mol %.

In alternate non-limiting embodiments of the present invention, the aqueous solution of the cationic nitrogen-containing polymeric dye fixative can include at least 5 wt. %, or at least 10 wt. %, or at least 15 wt. % of the nitrogen-containing polymer; and not more than 50 wt. %, or not more than 45 wt. %, or not more than 40 wt. % of the nitrogen-containing polymer. When the concentration of the nitrogen-containing polymer is too low, it is not economical for commercial applications and can be too dilute to provide optimum ratios with the polyurethane. When the concentration is too high, the solution can be too viscous to easily handle in a commercial environment. Non-limiting examples of cationic nitrogen-containing polymers useful in the present invention are solutions of polyamide amines reacted with epichlorohydrin, available under the trade name CinFix from Stockhausen GmbH & Co. K G, Krefeld, Germany.

The microporous substrate coating composition for use in the present invention includes a mixture of an aqueous solution of a cationic nitrogen-containing polymer and an aqueous polyurethane dispersion. The mixture comprises from 10 wt. % to 70 wt. %, or from 20 wt. % to 60 wt. %, or from 30 wt. % to 50 wt. % of an aqueous polyurethane dispersion. In alternate non-limiting embodiments, the mixture comprises from 30 wt. % to 90 wt. %, or from 40 wt. % to 80 wt. %, or from 50 wt. % to 70 wt. % of an aqueous solution of the cationic nitrogen-containing polymer. The weight percentages are based on the total weight of the microporous substrate coating composition.

In one non-limiting embodiment of the present invention, water can be added to the mixture of the cationic nitrogen-containing polymer and the polyurethane. When water is added to the mixture, the resulting microporous substrate coating composition has a total resin solids of from 1 wt. % to 35 wt. %, or from 1 wt. % to 20 wt. %, or from 1 wt. % to 10 wt. % based on the total weight of the microporous substrate coating composition. When the total resin solids is too high, the viscosity of the coating composition can be such that poor penetration of the coating composition results. When the total resin solids is too low, the viscosity of the coating composition can be such that poor coating to the substrate results. In one non-limiting embodiment, the viscosity of the coating composition of the present invention is less than 500 cps, or less than 400 cps; and at least 10 cps, or at least 25 cps when measured using a Brookfield viscometer (RVT, spindle no. 1, 50 rpm at 25° C.). Although the viscosity can vary outside of the aforementioned ranges, a viscosity within the aforementioned ranges provides for the coating composition to wet the substrate while maintaining a degree of porosity in the final coated substrate.

In one non-limiting embodiment, the coating composition for use in the present invention comprises a co-solvent. Any co-solvent known in the art can be used. Non-limiting examples of suitable co-solvents include lower alkyl alcohols, n-methylpyrrolidone, Dowanol PM, toluene, and glycol ethers.

The coating composition of the microporous substrate used in the present invention can comprise other additives typically known in the art. Non-limiting examples of such additives include surfactants, such as nonionic, cationic, anionic, amphoteric and zwiterionic surfactants; rheology modifiers, such as polyvinyl alcohols, polyvinyl pyrrolidones, polyethylene oxides, polyacrylamides, natural and synthetic gums; biocides, such as a blend of 5-chloro-2-methyl-4-isothiazoline-3-one and 2-methyl-4-isothiazolin-3-one available commercially by the trade name Kathon, from Rohm and Haas Co., 2-hydroxypropylmethane thiosulfonate, and dithiocarbamates; and coupling agents, such as titanium, silane-type, trisodium pyrophosphate.

Although the pH of the coating composition of the present invention can vary, in alternate non-limiting embodiments, the pH of the coating composition is generally less than 7, or less than 6, or less than 5. When the pH is outside of these ranges, the cationic polymeric dye fixative material can not carry a sufficient cationic charge to perform its intended function. Further, the wetting action of the coating composition can be improved when the pH is within the aforementioned ranges. In one non-limiting embodiment, the coating composition has pH greater than 2.

The coating composition can be prepared by methods known in the for microporous substrates. In one non-limiting embodiment of the present invention, the substrate coating composition is prepared by a method which includes the addition of the aqueous solution of a cationic nitrogen-containing polymer into an aqueous polyurethane dispersion. Sufficient mixing is maintained during the addition to ensure that a homogeneous mixture results. It has been observed that when the aqueous anionic polyurethane dispersion is added to the aqueous solution of a cationic nitrogen-containing polymer, coagulation occurs and a homogeneous mixture is not obtained.

The coating composition used in the present invention can be applied to the ink jet recordable substrate using any method that is known in the art. In one non-limiting embodiment, the method comprises:

(a) providing an microporous substrate having a top surface and a bottom surface;

(b) providing the coating composition described above; and

(c) at least partially applying the coating composition to at least one surface of the microporous substrate.

The thickness of the at least partially coated microporous substrate can vary. In alternate non-limiting embodiments of the present invention, the at least partially coated microporous substrate generally has a thickness of at least 0.1 mils, or from 0.5 to 100 mils, or from 1 to 50 mils, and in some cases from 4 to 14 mils. When the at least partially coated microporous substrate has a thickness which exceeds the aforementioned ranges, it can not feed properly through an ink jet printer. When the at least partially coated microporous substrate is below the stated ranges, it can not have sufficient strength for its intended use.

Any method known in the art can be used to apply the coating composition to the microporous substrate such as flexography, spraying, air knife coating, curtain coating, dipping, rod coating, blade coating, gravure, reverse roll, roller application, imbibing, size press, printing, brushing, drawing, slot-die coating, and extrusion.

Following application of the coating composition to said substrate, the solvent is removed from the applied coating by any conventional drying technique. In one non-limiting embodiment, the coating is dried by exposing the coated substrate to a temperature ranging from ambient to 350° F.

The coating composition can be at least partially applied at least one time to at least one surface of the substrate. When the coating composition is applied more than one time, the applied coating is usually but not necessarily dried, either partially or totally, between coating applications.

When the coating composition is at least partially applied to a microporous substrate, in one non-limiting embodiment, the coating composition can penetrate at least partially into the substrate. At least partial penetration of the coating into the microporous substrate can improve the ink jet print quality on the coated substrate. In one non-limiting embodiment, the coating can at least partially penetrates into at least the first one (1) micron of the surface of the microporous substrate. In alternate non-limiting embodiments, the coating can at least partially penetrate into at least the first ten (10) microns, or at least the first twenty (20) microns or at least the first thirty (30) microns of the microporous substrate.

The coating composition can be applied to the substrate by a variety of known techniques. In one non-limiting embodiment of the present invention, the coating composition can be applied to the substrate using an air knife coating technique where the excess coating is ‘blown off’ by a powerful jet from the air knife. In another one non-limiting embodiment, a reverse roll coating method is used. In this procedure, the coating composition is measured onto an applicator roller by precision setting of the gap between an upper metering roller and the application roller below it. The coating is wiped-off the application roller by the substrate as it passes around the support roller at the bottom.

In another one non-limiting embodiment of the present invention, gravure coating can be used to apply the coating composition. In the gravure coating method, an engraved roller runs in a coating bath, which fills the engraved dots or lines of the roller with the coating composition. Any excess coating on the roller is wiped off by a doctor blade and the coating is deposited onto the substrate as it passes between the engraved roller and a pressure roller. Reverse gravure coating methods can be used. In this method, the coating composition is metered by the engraving on a roller before being wiped off as in a conventional reverse roll coating process.

In a further non-limiting embodiment a metering rod can be used to apply the coating composition. When a metering rod is used, an excess of the coating is deposited onto the substrate as it passes over a bath roller. The wire-wound metering rod, sometimes known as a Meyer Bar, allows the desired quantity of the coating to remain on the substrate. The quantity is determined by the diameter of the wire used on the rod.

The amount of the substantially dry coating applied to the substrate, or “coat weight”, is typically measured as coating weight per coated area. The coat weight can vary widely. In alternate non-limiting embodiments, it can be at least 0.001 g/m², or at least 0.01 g/m², and in some cases at least 0.1 g/m². In alternate non-limiting embodiments, the coat weight is not more than 50 g/m², or not more than 40 g/m², and in some cases not more than 35 g/m². The coat weight can vary between any of the stated amounts.

In non-limiting embodiments, the substantially dried coating includes the polyurethane at from 10 to 70 percent, or from 20 to 60 percent, and in some cases from 30 to 55 percent by weight of the coating and the nitrogen-containing polymer at from 30 to 90 percent, or from 40 to 80 percent, and in some cases from 45 to 70 percent by weight of the coating. The amount of each component in the substantially dried coating can be determined by the amount of each used to prepare the coating composition.

As used herein and in the claims, “substantially dry” is used to refer to the coating that feels dry to touch.

The microporous substrate can be printed with a wide variety of printing inks using a wide variety of printing processes. Both the printing inks and the printing processes are themselves conventional and known in the art. In a non-limiting embodiment, the microporous substrate of the present invention can be used as an ink jet recordable substrate for ink jet printing. Printing can be accomplished prior to assembly of the microporous material into multilayer articles of the present invention or following the assembly of such multilayer articles.

In the present invention, the substantially water-resistant, at least partially coated, microporous substrate can be connected to at least one application of a substantially nonporous material. As used herein and the claims, the term “connected to” means to link together or place in relationship either directly, or indirectly by one or more intervening materials. As used herein and the claims the term “substantially nonporous material” refers to a material which is generally impervious to the passage of liquid, gas, and bacteria. On a macroscopic scale, a substantially nonporous material exhibits few if any pores. As previously mentioned, used herein and the claims, the term “pore(s)” refers to a minute opening(s) through which matter passes. Substantially nonporous materials for use in the present invention may vary widely and can comprise those materials customarily recognized and employed for their known barrier properties. Non-limiting examples of such materials include substantially nonporous thermoplastic polymers, substantially nonporous metalized thermoplastic polymers, substantially nonporous thermoset polymers, substantially nonporous elastomerics, and substantially nonporous metals. The substantially nonporous material can be in the form of a sheet, film, or foil, or other shapes can be used when desired, such as for example, plates, bars, rods, tubes, and forms of more complex shape. In one non-limiting embodiment, the substantially nonporous material for use in the present invention can be in the form or a sheet, film or foil.

As used herein and the claims, the term “thermoplastic polymer” refers to a polymer that can be softened by heat and then regain its original properties upon cooling. The term “thermoset polymer” as used herein and the claims refers to a polymer that solidifies or sets on heating and cannot be remelted.

Non-limiting examples of thermoplastic polymeric materials which are suitable for use include polyethylene, high density polyethylene, low density polyethylene, polypropylene, poly(vinyl chloride), saran, polystyrene, high impact polystyrene nylons, polyesters such as poly(ethylene terephthalate), copolymers of ethylene and acrylic acid, copolymers of ethylene and methacrylic acid, and mixtures thereof. If desired, all or a portion of the carboxyl groups of carboxyl-containing copolymers can be neutralized with sodium, zinc, or the like. A non-limiting example of a metalized thermoplastic polymeric material is aluminized poly(ethylene terephthalate).

Non-limiting examples of thermoset polymeric materials include thermoset phenol-formaldehyde resin, thermoset melamine-formaldehyde resin, and mixtures thereof.

Non-limiting examples of elastomeric materials include natural rubber, neoprene, styrene-butadiene rubber, acrylonitrile-butadiene-styrene rubber, elastomeric polyurethanes, and elastomeric copolymers of ethylene and propylene.

Non-limiting examples of metals include iron, steel, copper, brass, bronze, chromium, zinc, die metal, aluminum, and cadmium. Most often the metals employed are alloys and thermoset polymers that can be used in the present invention include a wide variety of polymers known in the art.

The multilayer article of the present invention can be constructed using a wide variety of known methods for connecting at least one layer of a microporous substrate with at least one layer of a substantially nonporous material. In one non-limiting embodiment, at least one layer of a substantially water-resistant, at least partially coated microporous substrate can be fusion bonded to at least one layer of a substantially nonporous material. The microporous substrate generally comprises opposed major surfaces which are characteristic of sheets, films, foils, and plates. The resulting multilayer article can comprise one layer or more than one layer of the microporous substrate and one layer or more than one layer of the substantially nonporous material. In one non-limiting embodiment, at least one exterior layer is the microporous substrate. In an alternate non-limiting embodiment, the microporous substrate can be an ink jet recordable substrate.

In one non-limiting embodiment, the multilayer article of the present invention can be produced by fusion bonding in the absence of an adhesive. Fusion bonding can be accomplished using conventional techniques such as sealing through use of heated rollers, heated bars, heated plates, heated bands, heated wires, flame bonding, radio frequency (RF) sealing, and ultrasonic sealing. Solvent bonding can be used where the substantially nonporous substrate is at least partially soluble in the applied solvent to the extent that the surface becomes tacky. The microporous substrate can be contacted with the tacky surface, and the solvent is then removed to form the fusion bond. In a non-limiting embodiment, foamable compositions can be foamed in contact with the microporous substrate to form a fusion bond between the foam and the substrate. Films or sheets of nonporous substrate can be extruded and while still hot and tacky, contacted with the microporous substrate to form a fusion bond. The fusion bond can be permanent or peelable, depending upon the known bonding technique and/or the nature of the substantially nonporous substrate employed.

In one non-limiting embodiment, heat sealing is used to fusion bond the microporous substrate to the substantially nonporous material. In general, heat sealing includes inserting the microporous substrate into standard heat sealing equipment which is known in the art. In one non-limiting embodiment, the microporous substrate is inserted in conjunction with the substantially nonporous material which can be a thermoplastic and/or thermoset polymer. Heat and/or pressure can be applied to the substrate/polymer construction for a period of time. The amount of heat and/or pressure and length of time can vary widely. In general, the temperature, pressure and time are selected such that the substrate and polymer are at least partially connected together to form a multilayer article. A typical temperature can be within the range of from 100° F. to 400° F. A typical pressure can be within the range of from 5 psi to 250 psi, and a typical period of time can be in the range of from one (1) second to thirty (30) minutes. The multilayer article can then be cooled while under pressure for a typical period of time, such as thirty (30) minutes. Although the strength of the bond formed between the substrate and polymer can vary, the strength can be such that it generally exceeds the tensile properties of the substrate alone.

In one non-limiting embodiment, the substantially nonporous substrate can be polyvinyl chloride.

In one non-limiting embodiment, the microporous substrate employed in the present invention can be at least partially connected to a nonporous substrate such as polyethylene and polypropylene by heat sealing in the absence of an extrinsic adhesive. The resultant fusion bond is ordinarily sufficiently strong which is surprising inasmuch as the lamination of materials to polyolefins is usually difficult unless special adhesives are used.

In one non-limiting embodiment, the microporous substrate can be substantially continuously at least partially connected to the substantially nonporous substrate, or it can be discontinuously at least partially connected to the substantially nonporous substrate. Non-limiting examples of discontinuous bonds include bonding areas in the form of one or more spots, patches, strips, stripes, chevrons, undulating stripes, zigzag stripes, open-curved stripes, closed-curved stripes, irregular areas, and the like. In an alternate non-limiting embodiment, when patterns of bonds are involved, they can be random, repetitive, or a combination of both.

In another one non-limiting embodiment, a microporous substrate can be connected to a substantially nonporous material in the presence of an adhesive. The adhesive for use in the present invention can be selected from a wide variety of adhesives known in the art. Non-limiting examples of suitable adhesives include those having a sufficient molecular weight and viscosity such that the adhesive will not substantially migrate into or substantially penetrate the microporous substrate. Migration or penetration of the adhesive into the substrate can reduce the tack and bond strength of the adhesive. Non-limiting examples of suitable adhesives for use in the present invention include but are not limited to polyvinyl acetate, starches, gums, polyvinyl alcohol, animal glues, acrylics, epoxies, polyethylene-containing adhesives, and rubber-containing adhesives. The adhesive can be applied to the substrate, or to the substantially nonporous material, or to both the substrate and the substantially nonporous material. Further, the adhesive can be introduced via the use of a tie carrier coating.

The process of bonding the substrate and substantially nonporous material in the presence of an adhesive generally includes inserting the substrate/adhesive/material construction into standard processing equipment which is known in the art. Heat and/or pressure can be applied to the substrate/adhesive/material construction for a period of time. The amount of heat and/or pressure and length of time can vary widely. In general, the temperature, pressure and time are selected such that the substrate and substantially nonporous material are at least partially connected together to form a multi-layer article. A typical temperature can be within the range of from 100° F. to 400° F. A typical pressure can be within the range of from 5 psi to 250 psi, and a typical period of time can be in the range of from one (1) second to thirty (30) minutes. The multilayer article may then be cooled under pressure for a typical time period, such as thirty (30) minutes. Although the strength of the bond formed between the microporous substrate and the substantially nonporous material can vary, the bond is generally such that it typically exceeds the tensile properties of the substrate alone.

In one non-limiting embodiment of the present invention, a microporous substrate can be molded using conventional molding techniques known in the art. The substrate can be molded in the presence or the absence of a substantially nonporous material, such as a thermoplastic and/or thermoset polymer. In general, the microporous substrate is inserted into standard molding equipment which is known in the art. In one non-limiting embodiment, a thermoplastic and/or thermoset polymer is introduced onto the substrate and then the substrate/polymer construction is inserted into the mold cavity. In another one non-limiting embodiment, the substrate is placed into the mold cavity and then the thermoplastic and/or thermoset polymer is introduced onto the substrate. Heat and/or pressure can be applied to the substrate/polymer construction for a period of time. The amount of heat and/or pressure and length of time can vary widely. In general, the temperature, pressure and time are selected such that the substrate and polymer are at least partially connected together to form a multi-layer article. A typical temperature can be within the range of from 100° F. to 400° F. In a non-limiting embodiment, wherein the polymer comprises a thermoplastic polymer, the substrate/polymer construction can be heated to a temperature that equals or exceeds the melt temperature of the thermoplastic polymer. In one non-limiting embodiment, where the thermoplastic polymer can be amorphous, the substrate polymer construction can be heated to a temperature that equals or exceeds the Vicat temperature. In an alternative non-limiting embodiment, wherein the polymer comprises a thermoset polymer, the temperature can be below the curing or crosslinking temperature of the polymer. A typical pressure can be within the range of from 5 psi to 250 psi, and a typical period of time can be in the range of from one (1) second to fifteen (15) minutes. The result of a typical molding process is a re-shaping of the original article. The re-shaping is generally defined by the design of the mold cavity. Thus, in a standard molding process, a two-dimensional flat sheet can be re-shaped into a three-dimensional article.

In one non-limiting embodiment of the present invention, the microporous substrate comprises Teslin which is available from PPG Industries, Incorporated in Pittsburgh, Pa. The thickness of the microporous substrate of the present invention varies widely depending on the application for use. In one non-limiting embodiment, the microporous substrate can be from 5 to 20 mils thick.

In general, the multilayer article of the present invention can be produced employing a variety of molding and laminating procedures known in the art, which include but are not limited to compression molding, rotational molding, injection molding, calendering, roll/nip laminating, thermoforming, vacuum forming, extrusion coating, continuous belt laminating, and extrusion laminating.

In one non-limiting embodiment, other tie coatings known in the art can be used in conjunction with the substrate and the substantially nonporous material.

In a non-limiting embodiment, a friction-reducing coating composition can be at least partially applied to at least one of the microporous substrate and the substantially nonporous material. In a further non-limiting embodiment, the friction-reducing coating composition can comprise at least one lubricant and at least one resin. There are a wide variety of lubricants and resins known to the skilled artisan that could be useful herein. Non-limiting examples of such suitable lubricants can include natural and synthetic waxes, natural and synthetic oils, polypropylene waxes, polyethylene waxes, silicone oils and waxes, polyesters, polysiloxanes, hydrocarbon waxes, carnauba waxes, microcrystalline waxes and fatty acids, and mixtures thereof. In a non-limiting embodiment, the lubricant for use in the present invention can include polysiloxanes, such as but not limited to silicone.

Non-limiting examples of suitable resins can include polyurethanes, polyesters, polyvinyl acetates, polyvinyl alcohols, epoxies, polyamides, polyamines, polyalkylenes, polypropylenes, polyethylenes, polyacrylics, polyacrylates, polyalkylene oxides, polyvinyl pyrrolidones, polyethers, polyketones, and co-polymers and mixtures thereof. In a non-limiting embodiment, the resin for use in the present invention can include styrene acrylic polymers such as but not limited to styrene acrylic-comprising polyurethanes, polyepoxies, polyvinyl alcohols, polyesters, polyethers, and co-polymers and mixtures thereof.

In a non-limiting embodiment, the friction-reducing coating composition for use in the present invention can include Wikoff SCW 4890 and 2295 which are commercially available from Wikoff Industries, Incorporated, as poly board aqua coat products.

Not intending to be bound by any particular theory, it is believed that the resin component of the friction-reducing coating can be at least partially interconnected or interlinked with the microporous substrate and/or the substantially nonporous material, such that the silicone can be essentially fixed to the surface of said substrate and/or said material. In a non-limiting embodiment, the molecules of a thermoplastic resin component can be interconnected by fusion to the ink jet recordable substrate and/or the substantially nonporous material. In another non-limiting embodiment, the molecules of a thermoset resin component can be interlinked by crosslinking to the ink jet recordable substrate and/or the substantially nonporous material.

In a further non-limiting embodiment, the friction-reducing coating composition can comprise water and/or an organic solvent. A wide variety of organic solvents known to the skilled artisan can be useful herein. Non-limiting examples of such suitable organic solvents can include but are not limited to N-methyl pyrrolidone (NMP), methyl ethyl ketone (MEK), acetone, diethyl ether, toluene, Dowanol PM, Butyl Cellosolve, and mixtures thereof. In a non-limiting embodiment, the friction-reducing coating composition can comprise water and an organic solvent, wherein said organic solvent is at least partially miscible with water.

In a non-limiting embodiment, the friction-reducing coating composition can be at least partially applied to at least one of the microporous substrate and the substantially nonporous material of the present invention. Application of said friction-reducing coating composition to said substrate and/or said material can employ a wide variety of known techniques. In alternate non-limiting embodiments, the techniques described previously herein for applying the substantially water-resistant coating to the microporous substrate can be used for application of the friction-reducing coating composition to the microporous substrate and/or the substantially nonporous material.

The amount of the substantially dry friction-reducing coating applied to the substrate/material, or “coat weight”, is typically measured as coating weight per coated area. The coat weight can vary widely. In alternate non-limiting embodiments, the coat weight of the substantially dry friction-reducing coating can be at least 0.1 gram per square meter, or from greater than 0 to 50 grams per square meter, or from 1 gram per square meter to 15 grams per square meter.

In a non-limiting embodiment, the multilayer article of the present invention can include a 10 mil thick sheet of Teslin comprising a substantially water-resistant coating composition, a 10 mil sheet of polyvinylchloride, a 10 mil thick sheet of polyvinylchloride, and a 2 mil thick sheet of polyvinylchloride comprising a friction-reducing coating composition. In a further non-limiting embodiment, the friction-reducing coating composition can comprise a polysiloxane and a styrene acrylic polymer.

In a non-limiting embodiment, the multilayer article of the present invention can include a magnetizable material. As used herein and the claims, the term “magnetizable material” means a material to which magnetic properties can be communicated. A wide variety of magnetizable materials are known to one skilled in the art. Known magnetizable materials are available in various forms such as but not limited to sheet, film, tape or stripe.

Magnetizable materials for use in the present invention can be selected from a variety of materials capable of being magnetized by a magnetic field. Suitable magnetizable materials can include but are not limited to oxide materials. Non-limiting examples of suitable oxide materials can include ferrous oxide, iron oxide, and mixtures thereof. In a non-limiting embodiment, the oxide particles can be present in a slurry formulation.

Suitable magnetizable materials for use in the present invention can include those known in the art which demonstrate performance characteristics such as but not limited to the ability to be encoded with sufficient ease, ability to encode a sufficient amount of information, and ability to be erased with sufficient resistance. In a non-limiting embodiment, the amount of information encoded onto the magnetizable material can be referred to as the number of stages or tracks. The number of stages or tracks can vary. In alternate non-limiting embodiments, the magnetizable material for use in the present invention can have at least one (1) track, or not more than six (6) tracks, or from three (3) to four (4) tracks.

In a non-limiting embodiment, the resistance to erasure can be referred to as “coercivity”. In general, the higher the coercivity value, the greater the resistance to erasure. The coercivity value can vary. In alternate non-limiting embodiments, the magnetizable material for use in the present invention can have a coercivity of at least 200, or not more than 5000, or from 500 to 2500, or from 100 to 1500.

Non-limiting examples of suitable magnetizable materials for use in the present invention can include but are not limited to magnetic foils which are commercially available from JCP, Kurz, EMTEC and DuPont.

In a non-limiting embodiment, the magnetizable material can be at least partially connected to at least one or more materials selected from a protective material, a carrier material or an adhesive material. The protective material, carrier material and adhesive material can be selected from a wide variety of materials known in the art as useful for each function. Non-limiting examples of suitable protective materials can include but are not limited to PET (polyethylene terapthalate), polyester and combinations thereof. Non-limiting examples of carrier materials can include but are not limited to PET, polyester and combinations thereof. Non-limiting examples of suitable adhesive materials can include but are not limited to those recited herein.

In another non-limiting embodiment, the protective material can be at least partially connected to the magnetizable material, the magnetizable material can be at least partially connected to the carrier material, and the carrier material can be at least partially connected to the adhesive material.

In alternate non-limiting embodiments, the magnetizable material can be at least partially connected to an ink jet recordable substrate and/or at least one substantially nonporous material. Non-limiting examples of ink jet recordable substrates can include but are not limited to those previously recited herein. In a non-limiting embodiment, the ink jet recordable substrate can be a microporous substrate such as those previously recited herein. In a further non-limiting embodiment, the microporous substrate can be Teslin® printing sheet which is commercially available from PPG Industries, Incorporated. Non-limiting examples of suitable substantially nonporous materials can include but are not limited to those previously recited herein. In a non-limiting embodiment, the substantially nonporous material can be polyvinyl chloride.

The magnetizable material-containing multilayer article of the present invention can be prepared by various methods known in the art. In a non-limiting embodiment, the magnetizable material can be at least partially connected to at least one substantially nonporous material. Various application techniques suitable for at least partially connecting the magnetizable material to the substantially nonporous material are known to a skilled artisan. In a non-limiting embodiment, the magnetizable material can be at least partially connected using an adhesive material. Non-limiting examples of suitable adhesive materials can include but are not limited to a wide variety of adhesives known to the skilled artisan, such as but not limited to those previously recited herein. In a non-limiting embodiment, the adhesive material can be selected from thermal- or pressure-sensitive adhesives.

In a further non-limiting embodiment, the magnetizable material can be at least partially connected to the adhesive material, and the adhesive material can be at least partially connected to a surface of the microporous substrate and/or at least one substantially nonporous material.

In alternate non-limiting embodiments, the magnetizable material can be at least partially connected to a microporous substrate and/or at least one substantially nonporous material prior to, during, or following a conventional lamination process such as but not limited to the lamination process previously described herein.

In another non-limiting embodiment, the magnetizable material can be essentially flush with the surface of the microporous substrate and/or substantially nonporous material to which it can be connected.

In a non-limiting embodiment, a substantially water-resistant coating composition can be at least partially applied to the magnetizable material. In alternate non-limiting embodiments, the coating can be at least partially applied to the magnetizable material either prior to or following at least partially connecting the magnetizable material to a microporous substrate or a substantially nonporous material. In a further non-limiting embodiment, an adhesive material can be at least partially applied to the uncoated surface of the magnetizable material, and the adhesive-containing surface can be at least partially connected to the microporous substrate or substantially nonporous material. In alternate non-limiting embodiments, the substantially water-resistant coating composition can be at least partially applied to at least one of the magnetizable material, the microporous substrate and the substantially nonporous material. In still a further non-limiting embodiment, the substantially water-resistant coating composition can include that which is recited herein.

In a non-limiting embodiment, a friction reducing coating composition can be at least partially applied to the magnetizable material. In alternate non-limiting embodiments, the coating can be at least partially applied to the magnetizable material either prior to or following at least partially connecting the magnetizable material to a micorporous substrate or a substantially nonporous material. In a further non-limiting embodiment, an adhesive material can be at least partially applied to the uncoated surface of the magnetizable material, and the adhesive-containing surface can be at least partially connected to the microporous substrate or substantially nonporous material. In alternate non-limiting embodiments, the friction reducing coating composition can be at least partially applied to at least one of the magnetizable material, the microporous substrate, and substantially nonporous material. In still a further non-limiting embodiment, the substantially friction reducing coating composition can include that which is recited herein.

The coating compositions can be applied by a variety of methods known in the art. In alternate non-limiting embodiments, the coating compositions can be applied by the methods previously described herein.

In a further non-limiting embodiment, a multilayer article of the present invention can include a microporous substrate at least partially connected to a first substantially nonporous material; the first substantially nonporous material can be at least partially connected to a second substantially nonporous material; the second substantially nonporous material can be at least partially connected to a third substantially nonporous material; said third substantially nonporous material can include a magnetizable material. In a further non-limiting embodiment, the microporous substrate and/or substantially nonporous materials can be at least partially connected using an adhesive material which can be at least partially applied to at least one surface of the substrate and/or materials.

In another non-limiting embodiment, a release liner can be at least partially connected to at least one surface of the multilayer article of the present invention. The release liner can function as a barrier to essentially prevent or minimize damage of the article during the manufacture process. In a non-limiting embodiment, a coating residue can be deposited on the stainless steel equipment during the lamination process as a result of print-off. Deposition of the coating on the equipment can result in at least partial damage to the coated surface of the multilayer article. In alternate non-limiting embodiments, a release liner can be at least partially connected to a coated or uncoated magnetizable material, a coated or uncoated substantially nonporous material, and/or a coated or uncoated microporous substrate.

The release liner can be selected from a wide variety of materials known in the art to perform the above-stated function. In general, a material suitable for use as a release liner in the present invention can have at least one of the following characteristics: a melt temperature in excess of the lamination temperature, the ability to essentially not migrate into the material and an acceptable tear strength such that it can be pulled away with sufficient ease.

In a further non-limiting embodiment, the microporous substrate, the substantially non-porous material, and magnetizable-containing substantially non-porous material can be aligned in an essentially parallel configuration to form a stacked article.

In another non-limiting embodiment, the microporous substrate can be at least partially connected to the substantially nonporous material in the absence of an adhesive material. In another non-limiting embodiment, the substantially nonporous material can be at least partially connected to another substantially nonporous material in the absence of an adhesive material.

In another non-limiting embodiment, the multilayer article of the present invention can include a data transmittance/storage device. Such devices can vary widely. Suitable devices for use in the present invention can include those known in the art. In a non-limiting embodiment, the device can include an antenna, electronic chip and/or other related circuitry. In a further embodiment, the device can include a carrier material. The carrier material can be selected from a wide variety of materials known in the art. In a non-limiting embodiment, the carrier material can be a substantially nonporous material. Suitable substantially nonporous materials can include those previously recited herein. In a non-limiting embodiment, the carrier material can be polyvinylchloride.

In still a further embodiment, the device can include a barrier material on at least one side of the circuitry. A function of the barrier material can be to encompass the circuitry and provide a substantially flat surface on the outside of the device. The barrier material can be selected from a wide variety of materials known in the art. In a non-limiting embodiment, the barrier material can be a substantially nonporous material. Suitable substantially nonporous materials can include those previously recited herein. In a non-limiting embodiment, the barrier material can be polyvinylchloride.

In a non-limiting embodiment, the multilayer article of the present invention can include an ink jet recordable substrate, a data transmittance/storage device, and at least one substantially nonporous material. The ink jet recordable substrate can be selected from a wide variety of such materials known in the art. Suitable non-limiting examples can include those previously described herein. In a non-limiting embodiment, the ink jet recordable substrate can be a microporous substrate such as those previously recited herein. In a further non-limiting embodiment, the ink jet recordable substrate can be Tesling printing sheet which is commercially available from PPG Industries, Incorporated. As previously described herein, the ink jet recordable substrate can be at least partially coated on at least one surface or uncoated. Suitable coating compositions can include those previously described herein. In a non-limiting embodiment, a substantially water-resistant coating composition can be at least partially applied to the ink jet recordable substrate.

The substantially nonporous material can be selected from a wide variety of such materials known in the art. Suitable non-limiting examples of substantially nonporous materials can include those previously described herein. In a non-limiting embodiment, the substantially nonporous material can be polyvinylchloride. As previously described herein, the substantially nonporous material can be at least partially coated on at least one surface or uncoated. Suitable coating compositions can include those previously described herein. In a non-limiting embodiment, a friction-reducing coating composition can be at least partially applied to the substantially nonporous material.

In a further non-limiting embodiment, the data transmittance/storage device can be at least partially connected to the barrier material using an adhesive material. A wide variety of suitable adhesive materials and methods of application are known in the art. Non-limiting examples include those adhesive materials and methods of application previously described herein.

In another non-limiting embodiment, the barrier material can have at least one surface at least partially coated with a coating composition. Suitable coating compositions can include those previously described herein. In a non-limiting embodiment, a friction-reducing coating composition can be at least partially applied to the barrier material.

In a non-limiting embodiment, the multilayer article with magnetizable material or with a transmittance/storage device, can have a thickness that varies widely. In alternate non-limiting embodiments, the thickness of the article can be at least 10 mils, or less than 60 mils, or from 30 to 50 mils.

The multilayer article with magnetizable material or with a data transmittance/storage device can be useful in a wide variety of applications. In alternate non-limiting embodiments, it can be used in applications related to security access, access-control, data storage and data transmittance.

The multilayer article of the present invention has many and varied uses including gaskets, cushion assemblies, signs, cards, printing substrates, substrates for pen and ink drawings, maps (particularly maritime maps), book covers, book pages, wall coverings, and seams, joints, and seals of breathable packages.

The multilayer article of the present invention can be useful for the purpose of decorating or identifying the substantially nonporous material, or imparting to the substantially nonporous material unique properties of the substrate surface. The ink jet recordable substrate can be decorated with a variety of methods including: offset/lithographic printing, flexographic printing, painting, gravure printing, inkjet printing, electrophotographic printing, sublimation printing, thermal transfer printing, and screen printing. Decorating can also include applying a single or multilayer coating to the ink jet recordable substrate via normal coating methods known in the art. In general, the unique properties that an ink jet recordable substrate can impart on a substantially nonporous material include, but are not limited to one or more of: improved surface energy, increased porosity, decreased porosity, increased bond strength of post coat layer, and modification of the polymer's surface texture or pattern.

Polymer processing techniques are disclosed in U.S. Pat. No. 4,892,779, which is incorporated herein by reference.

The present invention is more particularly described in the following examples, which are intended to be illustrative only, since numerous modifications and variations therein will be apparent to those skilled in the art. Unless otherwise specified, all parts and percentages are by weight.

### EXAMPLES

### Example 1

### Thermal Lamination

A sheet of TS 1000 (which was available from PPG Industries, Incorporated, under the trade name Teslin) measuring 8.5×11 inches was cut from a master roll. The Teslin sheet was coated using four (4) passes on each side. The coating composition used to coat the Teslin was prepared by first diluting a 31% solids anionic polyurethane sold under the trade name WitcoBond 234 (available from Crompton Corporation, Greenwich, Conn.), to 12.3% solids in a stainless steel mix tank under high speed mixing with an overhead mixer. In a separate feed tank a 55% solids solution of a polyamide amine reacted with dimethylamine and epichlorohydrin (available under the trade name CinFix NF by Stockhausen GmbH & Co. K G, Drefeld, Germany), was diluted to 7.7% solids and then subsequently added to the diluted anionic polyurethane dispersion, at a 50/50 volume ratio, and the mixture was mixed for 15 minutes. The pH was adjusted to 5.0+/−0.5. The total resin solids of the mixture was 10%.

The coating composition was applied to the sheet of Teslin (10 mil thick) using flexographic coating technology which included two coating stations containing forced air drying ovens. Each coating station consisted of a coating feed chamber, anilox roll and rubber roll. The coating feed chamber was supplied from a coating holding tank and pump. Only one coating station was used in the preparation of this material. The apparatus was fitted with a 7 bcm (billion cubic microns) anilox roll, the line speed was 180 fpm (feet per minute), and the oven temperature was 105° C. (220° F.). Eight (8) passes per roll were made, which corresponds to four (4) passes per surface.

A test print was then printed onto the sheet using an HP1220C color inkjet printer. The printed sheet was laminated using the following lamination peel strength test method. The 8.5×11 inch sheet of Teslin was covered with an 8.5×11 inch Sealtran 3/2 laminating film. A 2×11 inch strip of 20 lb. bond paper was placed along the center line (in the 11 inch direction) on the Teslin. The film to be tested was cut to 8.5 inch by 11 inch and placed directly on top of the aforementioned structure. The laminated sheet was cut into a piece 4.25 inches by 11 inches. Strips were then cut (1 inch by 4.25 inches) using a JDC Precision Sample Cutter (Thwing Albert Instruments). Each strip was placed in a silicone-coated “laminating pocket”. The pocket was fed through a pocket laminator large enough to accommodate the pocket. The laminating roll temperature varied within a range of from 275 to 300° F. (120-135° C.). The laminated samples were then stored at room temperature for at least 24 hours prior to peel testing. The laminating film was peeled back from the Teslin and placed into the top jaw of a tensile tester. The bottom portion was placed into the bottom jaw of the tensile tester. A 180° peel was performed at 0.5 inches/minute with a sample rate of 4.0 pt./second. The test results showed the initial peel strength was 9.6 lbs./inch and demonstrated that the resulting substrate retained its integrity following a 24 hour water soak.

### Example 2

### Thermal Lamination

A sheet of TS 1000 measuring 8.5×11 inches was cut from a master roll of Teslin. The Teslin had been coated using two (2) passes on each side. The coating composition which was used to coat the Teslin had been prepared using a high shear coating procedure. Under high shear mixing, 61.5 active parts of Witcobond 234 having 31% solids in water was added at a controlled rate into 38.5 active parts of CinFix NF at 52% solids in water. The resultant Witcobond 234/CinFix NF mixture was reduced to a final mixture of 10% solids by adding water at a controlled rate while continuing the high shear mixing. The procedure used to apply this coating composition to the Teslin was the same as that used in Example 1. Three test patterns (supplied by HP) were printed on the coated Teslin sheet using an HP 1220° C. color inkjet printer. The printed sheet was then laminated using the same lamination process as that described in Example 1, with the exception that the pocket laminator had a temperature of 225° F. and Transilwrap 7/3 KRTY Polyester was used as the laminating film. The laminated sheets were than diecut into 70 ISO 7810 ID-1 cards. The cards exhibited good integrity when laminated. No quantitative testing was performed.

### Example 3

### Hydraulic Platen Lamination

A sheet of TS 1000 measuring 14×14 inches was cut from a master roll of Teslin. The Teslin had been coated with two (2) passes on each side (2×2) using the same coating composition as used in Example 2 and the same Flexographic coating technology that was used in Example 1. The coated Teslin sheet was then placed on top of two 14×14 inch sheets of 0.010 inch polyvinylchloride (PVC), supplied by Empire Plastics. This construction was placed in a Technical Machine Products (TMP) laminating press. The composite construction was compression laminated at a pressure of 200 psi for 10 minutes at a temperature of 200° F. Following lamination, IS07910 ID-1 cards were diecut from the finished 14×14 inch construction. The finished cards had good integrity; any attempt to delaminate them destroyed the Teslin layer, which demonstrated a good bond between the Teslin and the PVC in the absence of an adhesive.

### Example 4

### Hydraulic Platen Lamination

A sheet of TS 1000 measuring 14×14 inches was cut from a master roll of Teslin that was coated with two (2) passes on each side (2×2) using the same coating composition used in Example 2, and the same Flexographic coating technology for application as was used in Example 1. The coated Teslin sheet was placed on top of one sheet of 14 inch×14 inch, 0.010″ thick PVC (supplied by Empire Plastics) and one 14×14 inch sheet of 0.015″ thick PVC. The construction was placed in a Technical Machine Products (TMP) laminating press. The composite construction was compression laminated at a pressure of 175 psi for 10 minutes at a temperature of 185° F. Following lamination, IS07910 ID-1 cards were diecut from the finished 14 inch×14 inch construction. The finished cards demonstrated good integrity and any attempt to delaminate them destroyed the Teslin layer; demonstrating a good bond between the Teslin and the PVC in the absence of an adhesive.

### Example 5

### Hydraulic Platen Lamination

A sheet of TS 1000 measuring 14×14 inch was cut from a master roll of Teslin that was coated two (2) passes each side (2×2) using the same coating composition used in Example 2 and the same Flexographic coating technology for applying the coating that was used in Example 1. The coated Teslin sheet was placed on top of one sheet of 14 inch×14 inch, 0.010 inch thick PVC (supplied by Empire Plastics) and one 14 inch×14 inch sheet of 0.015 inch thick PVC. This construction was then placed in a Technical Machine Products (TMP) laminating press. The composite construction was compression laminated at a pressure of 175 psi for 5 minutes at a temperature of 185° F. Following lamination, IS07910 ID-1 cards were diecut from the finished 14×14 inch construction. The finished cards had good integrity; any attempt to de-laminate them destroyed the Teslin layer, demonstrating a good bond between the PVC and the Teslin in the absence of adhesive.

### Example 6

### Hydraulic Platen Lamination

A 14 inch by 14 inch sheet of TS1000 was cut from a master roll of Teslin that was coated with two (2) passes each side (2×2) using the same coating composition used in Example 2, and the same Flexographic coating technology for applying said coating composition used in Example 1. The coated Teslin sheet was placed on top of one sheet of 14 inch by 14 inch, 0.010 inch thick PVC (supplied by Empire Plastics) and one 14 inch by 14 inch sheet of 0.015 inch thick PVC. This construction was placed in a Technical Machine Products (TMP) laminating press. The composite construction was then compression laminated at a pressure of 175 psi for 4 minutes at a temperature of 175° F. Following lamination, IS07910 ID-1 cards were diecut from the finished 14 inch by 14 inch construction. The finished cards were then separated, demonstrating lack of good bond between Teslin and PVC.

### Example 7

### Hydraulic Platen Lamination (One Composite Sheet/Book)

A Teslin sheet measuring 22.75×27.75 inches, 10 mils thick, was cut from a master roll in the grain long direction. The Teslin had been coated with three (3) passes on each side (3×3) using the same coating composition and Flexographic coating technology described in Example 2. The coated Teslin sheet was placed on top of one 22.75×27.75 inch sheet of 0.020-inch polyvinylchloride (Klockner PVC 280/09 copolymer). The PVC sheet was cut in the grain long direction. A sheet of 2-mil clear polyester measuring 24×30 inch was placed over the Teslin sheet to act as a release liner. The release liner was removed from the composite sheet following lamination and was not part of the final composite sheet. This construction was placed between two 24 inch×30 inch×125 mil polished stainless steel metal plate. This entire construction was placed in a 200-Ton Wabash laminating press, preheated to 250° F. The composite construction was compression laminated at a pressure of 175 psi for 12 minutes at a temperature of 250° F. While under pressure, the platens were cooled to less than 100° F., which took approximately 20 minutes. After being removed from the press, the resultant composite sheet was removed from the stack construction. The finished composite sheet had good integrity; any attempt to delaminate destroyed the Teslin layer, which demonstrated a good adhesive and seamless bond between the Teslin and the PVC. IS07910 ID-1 cards were die cut from the resultant 22.75-inch×27.75-inch×29.0 mil composite sheet. The finished cards had good integrity and good lat flat. Any attempt to delaminate destroyed the Teslin layer, which demonstrated a good adhesive and seamless bond between the Teslin and the PVC.

### Example 8

### Hydraulic Platen Lamination (Two Composite Sheets/Book)

A sheet of Teslin measuring 22.75×27.75 inch of treated Teslin substrate, 10 mils thick, was cut from a master roll in the grain long direction. The Teslin had been coated with three (3) passes on each side (3×3) using the same coating composition and Flexographic coating technology described in Example 2. The coated Teslin sheet was placed on top of a 22.75×27.75-inch sheet of 0.020-inch polyvinylchloride (Klockner PVC 280/09 copolymer). The PVC sheet was cut in the grain long direction. A sheet of 2-mil clear polyester measuring 24-inch×30-inch was placed over the Teslin sheet to act as a release liner. The release liner was removed from the composite sheet following lamination and was not an integral part of the final composite sheet. This construction was placed between two 24 inch×30 inch×125 mil polished stainless steel metal plate. An identical polyester/treated Teslin sheet/PVC lay-up was placed on top of a stainless plate from the existing construction. A polished metal plate was placed over the exposed polyester release liner. This entire construction was placed in a 200-Ton Wabash laminating press, preheated to 250° F. The composite construction was compression laminated at a pressure of 175 psi for 12 minutes at a temperature of 250° F. While under pressure, the platens were cooled to less than 100° F., which took approximately 20 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5 inch×27.5 inch×29.0 mil composite sheet. The finished cards had good integrity and good lat flat. Any attempt to delaminate destroyed the Teslin layer, which demonstrated a good adhesive and seamless bond between the Teslin and the PVC.

### Example 9

### Hydraulic Platen Lamination (Four Composite Sheets/Book)

A sheet of Teslin measuring 22.75×27.75 inches, 10 mils thick, was cut from a master roll in the grain long direction. The Teslin had been coated with three (3) passes on each side (3×3) using the same coating composition and Flexographic coating technology described in Example 2. A coated Teslin sheet was placed on top of a 22.75×27.75 inch sheet of 0.020-inch polyvinylchloride (Klockner PVC 280/09 copolymer). The PVC sheet was cut in the grain long direction. A 2-mil sheet of clear polyester measuring 24×30 inches was placed over the Teslin sheet to act as a release liner. The release liner was removed from the composite sheet following lamination and was not part of the final composite sheet. This construction was placed between two 24 inch×30 inch×125 mil polished stainless steel metal plate. An identical polyester/treated Teslin sheet/PVC lay-up was placed on top of a stainless plate from the existing construction. A polished metal plate was placed over the exposed polyester release liner. The pattern was repeated twice such that four (4) pre-pressed multi-layer ply's existed in the stack. This entire construction was placed in a 200-Ton Wabash laminating press, preheated to 250° F. The composite construction was compression laminated at a pressure of 175 psi for 12 minutes at a temperature of 250° F. While under pressure, the platens were cooled to less than 100° F., which took approximately 20 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5-inch×27.5-inch×29.0 mil composite sheet. The finished cards had good integrity and good lat flat. Any attempt to delaminate destroyed the Teslin layer, which demonstrated a good adhesive and seamless bond between the Teslin and the PVC.

### Example 10

### Hydraulic Platen Lamination (Four Composite Sheets/Book)

A sheet of Teslin measuring 22.75×27.75 inches, 10 mils thick, was cut from a master roll in the grain long direction. The Teslin had been coated with three (3) passes on each side (3×3) using the same coating composition and Flexographic coating technology described in Example 2. A coated Teslin sheet was placed on top of a 22.75×27.75-inch sheet of 0.020-inch polyvinylchloride (Klockner PVC 280/09 copolymer). The PVC sheet was cut in the grain long direction. A 2-mil sheet of clear polyester measuring 24×30 inches was placed over the Teslin sheet to act as a release liner. The release liner was removed from the composite sheet following lamination and was not part of the final composite sheet. This construction was placed between two 24 inch×30 inch×125 mil polished stainless steel metal plates. An identical polyester/treated Teslin sheet/PVC lay-up was placed on top of a stainless plate from the existing construction. A polished metal plate was placed over the exposed polyester release liner. The pattern was repeated twice such that four (4) pre-pressed multi-layer ply's existed in the stack. This entire construction was placed in a 200-Ton Wabash laminating press, preheated to 250° F. The composite construction was compression laminated at a pressure of 175 psi for 10 minutes at a temperature of 250° F. While under pressure, the platens were cooled to less than 100° F., which took approximately 20 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5-inch×27.5-inch×29.0 mil composite sheet. The finished cards had good integrity and good lat flat. Any attempt to delaminate destroyed the Teslin layer, which demonstrated a good adhesive and seamless bond between the Teslin and the PVC.

### Example 11

### Hydraulic Platen Lamination (Four Composite Sheets/Book)

A sheet of Teslin substrate measuring 22.75×27.75 inches, 10 mils thick, was cut from a master roll in the grain long direction. The Teslin had been coated with three (3) passes on each side (3×3) using the same coating composition and Flexographic coating technology described in Example 2. A coated Teslin sheet was placed on top of one 22.75-inch×27.75-inch sheet of 0.020-inch polyvinylchloride (Klockner PVC 280/09 copolymer). The PVC sheet was cut in the grain long direction. A 2-mil thick sheet of clear polyester measuring 24×30 inches was placed over the Teslin sheet to act as a release liner. The release liner was removed from the composite sheet following lamination and was not part of the final composite sheet. This construction was placed between two 24 inch×30 inch×125 mil polished stainless steel metal plate. An identical polyester/treated Teslin sheet/PVC lay-up was placed on top of a stainless plate from the existing construction. A polished metal plate was placed over the exposed polyester release liner. The pattern was repeated twice such that four (4) pre-pressed multi-layer ply's existed in the stack. This entire construction was placed in a 200-Ton Wabash laminating press, preheated to 275° F. The composite construction was compression laminated at a pressure of 200 psi for 8 minutes at a temperature of 275° F. While under pressure, the platens were cooled to less than 100° F., which took approximately 22 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5-inch×27.5-inch×29.0 mil composite sheet. The finished cards had good integrity and good lat flat. Any attempt to delaminate destroyed the Teslin layer, which demonstrated a good adhesive and seamless bond between the Teslin and the PVC.

### Example 12

### Hydraulic Platen Lamination (Four Composite Sheets/Book)

Sheets 22.75-inch×27.75-inch of Teslin substrate, 10 mils thick, were cut from a master roll in the grain long direction. The Teslin had been coated with 3 passes on each side (3×3) using the same coating composition and Flexographic coating technology described in example 1. One coated Teslin sheet was placed on top of one 22.75-inch×27.75-inch sheet of 0.020-inch polyvinylchloride (Klockner PVC 280/09 copolymer). The PVC sheet was cut in the grain long direction. A sheet 24-inch×30-inch of 2-mil clear polyester was placed over the Teslin sheet to act as a release liner. (Note! This release liner is removed from the composite sheet following lamination and is not an integral part of the final composite sheet.) This construction was placed between two 24″×30″×125 mil polished stainless steel metal plate. An identical polyester/coated Teslin sheet/PVC lay-up was placed on top of a stainless plate from the existing construction. A polished metal plate was placed over the exposed polyester release liner. The pattern was repeated twice more so that four pre-pressed multi-layer ply's existed in the stack. This entire construction was placed in a 200-Ton Wabash laminating press, preheated to 275° F. The composite construction was compression laminated at a pressure of 200 psi for 6 minutes at a temperature of 275° F. While under pressure, the platens were cooled to less than 100° F., which took approximately 22 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5-inch×27.5-inch×29.0 mil composite sheet. The finished cards had good integrity and good lat flat. Any attempt to delaminate destroyed the Teslin layer, which demonstrated a good adhesive and seamless bond between the Teslin and the PVC.

### Example 13

### Hydraulic Platen Lamination (Four Composite Sheets/Book)—Failed

Sheets 22.75-inch×27.75-inch of Teslin substrate, 10 mils thick, were cut from a master roll in the grain long direction. The Teslin had been coated with 3 passes on each side (3×3) using the same coating composition and Flexographic coating technology described in example 1. One coated Teslin sheet was placed on top of one 22.75-inch×27.75-inch sheet of 0.020-inch polyvinylchloride (Klockner PVC 280/09 copolymer). The PVC sheet was cut in the grain long direction. A sheet 24-inch×30-inch of 2-mil clear polyester was placed over the Teslin sheet to act as a release liner. (Note! This release liner is removed from the composite sheet following lamination and is not an integral part of the final composite sheet.) This construction was placed between two 24″×30″×125 mil polished stainless steel metal plate. An identical polyester/treated Teslin sheet/PVC lay-up was placed on top of a stainless plate from the existing construction. A polished metal plate was placed over the exposed polyester release liner. The pattern was repeated twice more so that four pre-pressed multi-layer ply's existed in the stack. This entire construction was placed in a 200-Ton Wabash laminating press, preheated to 275° F. The composite construction was compression laminated at a pressure of 200 psi for 4 minutes at a temperature of 275° F. While under pressure, the platens were cooled to less than 100° F., which took approximately 20 minutes. After being removed from the press, all four composite sheets were removed from the book. The Teslin/PVC sheets were pealed apart, indicating lack of bond strength. No attempt to fabricate IS07910 ID-1 cards was made.

### Example 14

### Hydraulic Platen Lamination (Four Composite Sheets/Book)

A sheet of Teslin measuring 22.75×27.75 inches, 10 mils thick, was cut from a master roll in the grain long direction. The Teslin had been coated with three (3) passes on each side (3×3) using the same coating composition and Flexographic coating technology described in Example 2. One coated Teslin sheet was placed on top of one 22.75-inch×27.75-inch sheet of 0.024-inch polyvinylchloride (Klockner PVC 280/09 copolymer). The PVC sheet was cut in the grain long direction. A sheet 24-inch×30-inch of 2-mil clear polyester was placed over the Teslin sheet to act as a release liner. (This release liner is removed from the composite sheet following lamination and is not an integral part of the final composite sheet.) This construction was placed between two 24 inch×30 inch×125 mil polished stainless steel metal plate. An identical polyester/treated Teslin sheet/PVC lay-up was placed on top of a stainless plate from the existing construction. A polished metal plate was placed over the exposed polyester release liner. The pattern was repeated twice such that four pre-pressed multi-layer ply's existed in the stack. This entire construction was placed in a 200-Ton Wabash laminating press, preheated to 275° F. The composite construction was compression laminated at a pressure of 200 psi for 8 minutes at a temperature of 275° F. While under pressure, the platens were cooled to less than 100° F., which took approximately 22 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5-inch×27.5-inch×33.0 mil composite sheet. The finished cards had good integrity and good lat flat. Any attempt to delaminate destroyed the Teslin layer, which demonstrated a good adhesive and seamless bond between the Teslin and the PVC.

### Example 15

### Hydraulic Platen Lamination (Four Comiposite Sheets/Book)

A sheet of Teslin measuring 22.75×27.75 inches, 10 mils thick, was cut from a master roll in the grain long direction. The Teslin was coated with three (3) passes on each side (3×3) using the same coating composition and Flexographic coating technology described in example 1. A coated Teslin sheet was placed on top of one 22.75×27.75-inch sheet of 0.024-inch polyvinylchloride (Klockner PVC 280/09 copolymer). The PVC sheet was cut in the grain long direction. A 2-mil sheet of clear polyester measuring 24×30 inches was placed over the Teslin sheet to act as a release liner. The release liner was removed from the composite sheet following lamination and was not part of the final composite sheet. This construction was placed between two 24″×30″×125 mil polished stainless steel metal plate. An identical polyester/treated Teslin sheet/PVC lay-up was placed on top of a stainless plate from the existing construction. A polished metal plate was placed over the exposed polyester release liner: The pattern was repeated twice more so that four pre-pressed multi-layer ply's existed in the stack. This entire construction was placed in a 200-Ton Wabash laminating press, preheated to 275° F. The composite construction was compression laminated at a pressure of 200 psi for 6 minutes at a temperature of 275° F. While under pressure, the platens were cooled to less than 100° F., which took approximately 22 minutes. After being removed from the press, the resultant composite sheets were removed from the stack construction. The finished composite sheets had good integrity; any attempt to delaminate destroyed the Teslin layer, which demonstrated a good adhesive and seamless bond between the Teslin and the PVC. IS07910 ID-1 cards were die cut from the resultant 22.5-inch×27.5-inch×33.0 mil composite sheet. The finished cards had good integrity and good lat flat. Any attempt to delaminate destroyed the Teslin layer, which demonstrated a good adhesive and seamless bond between the Teslin and the PVC.

### Example 16

Coating composition Wikoff SCW 4890, manufactured and supplied by Wikoff Industries was applied to a 2 mil Klockner ZE84 pvc substrate sold by Klockner corp. A 8.5″×11″ sheet of 2 mil Klockner ZE84 was placed on a 15″×20″×20 mil backing sheet. A #9 metering bar was placed 1-2 inches above the top of the pvc sheet, parallel to the top edge. A 10-20 ml quantity of coating was drawn into a disposable plastic syringe. The coating was deposited as a bead strip (approximately ⅛ inches wide) directly next to and touching the Metering Bar. The bar was drawn completely across the sheet of pvc at a continuous/constant rate. The resultant wet sheet was placed in a forced air oven, secured and dried at 95° C. for 2 minutes. The sheet was then ready to be laminated and tested.

### Example 17

The 2 mil coated pvc sheet prepared as described in Example 16 was fabricated into cards using the following procedure. One coated Teslin sheet was placed on top of one 8.5-inch×11-inch sheet of 0.10-inch polyvinylchloride (PVC), supplied by Empire Plastics. The PVC sheet was cut in the grain long direction. Below the PVC ply was a second ply of 8.5-inch×11-inch×10 mil PVC, cut grain short. Below the 10 mil PVC grain short ply was the coated 8.5-inch×11-inch×2 mil PVC sheet cut grain long, positioned with the coated surface facing away from the adjacent 10 mil pvc ply. A sheet 12-inch×12-inch of 2-mil clear polyester was placed over the Teslin sheet to act as a release liner. This construction was placed between two 12″×12″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated two more times so that four pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a phi laminating press, preheated to 300° F. The composite construction was compression laminated at a pressure of 203 psi. The entire book was held under this condition for 30 minutes. Then while still under press, power to the platens was turned off long enough to allow the center plys of the book to reach 100° F. After being removed from the press, all four composite sheets were removed from the book. All four finished composite sheets had good integrity; any attempt to delaminate destroyed the Teslin layer, which demonstrated a good adhesive and seamless bond between the Teslin and the PVC. IS07910 ID-1 cards were die cut from the each composite sheet. The finished cards from each composite sheet had good integrity and good lat flat. The resultant cards demonstrated non-blocking behavior and required slip performance.

Card Slip Performance

| Friction | | |
|---|---|---|
| Force | | |
| Measurements | Uncoated | 4890 |
| 1 kg load | 2.122 | 0.773 |
| results (lb.) | | |
| Std dev. | 0.44 | 0.085 |
| % COV | 20.7 | 11.0 |

### Example 18

One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was a 20-inch×25-inch×2 mil PVC sheet of Klockner ZE84 cut grain long. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261° F. Then while still under press, the platens were cooled long enough to allow the same center plys to reach 100° F. After being removed from the press, all twelve composite sheets were removed from the book. All twelve composite sheets were topically treated with static guard on the pvc surface. All twelve finished composite sheets had good integrity; any attempt to delaminate destroyed the Teslin layer, which demonstrated a good adhesive and seamless bond between the Teslin and the PVC. IS07910 ID-1 cards were die cut using PMC high die equipment with the Teslin surface facing the cutting blade of the die. The finished cards from each composite sheet had good integrity and good lat flat. The resultant cards blocked slightly and did not demonstrate required slip performance.

### Example 19

One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was a 20-inch×25-inch×2 mil PVC sheet of Klockner ZE84 cut grain long. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261F. Then while still under press, the platens were cooled long enough to allow the same center plys to reach 100° F. After being removed from the press, all twelve composite sheets were removed from the book. All twelve composite sheets were topically treated with static guard on the pvc surface. All twelve finished composite sheets had good integrity; any attempt to delaminate destroyed the Teslin layer, which demonstrated a good adhesive and seamless bond between the Teslin and the PVC. IS07910 ID-1 cards were die cut using PMC high die equipment with the pvc surface facing the cutting blade of the die. The finished cards from each composite sheet had good integrity and good lat flat. The resultant cards demonstrated non-blocking behavior and required slip performance.

TABLE 1
Card Cutting Comparison

| | 1 kg Friction Force | Standard | |
|---|---|---|---|
| Card Type | (lb.) | Deviation | % COV |
| Lot #0022 (Teslin up) | 0.990 | 0.231 | 23.3 |
| Lot #0022 (PVC up) | 0.789 | 0.097 | 12.3 |

### Example 20

Coating composition Wikoff SCW 4890, manufactured and supplied by Wikoff Industries was applied to 300 ft of 2 mil Klockner ZE84 pvc sheet using a flexographic or gravure coating method. A single coating station was fixtured with a 6 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 200 fpm, oven temperature was 105° C. (220° F.) and a single coating pass was applied. The coating composition was applied with an approximate coat weight of 6.1 mg/sqin. The resultant coated roll was converted into 20″×25″ sheets, grain long.

### Example 21

Coating composition Wikoff SCW 4890, manufactured and supplied by Wikoff Industries was applied to 300 ft of 2 mil Klockner ZE84 pvc sheet using a flexographic or gravure coating method. A single coating station was fixtured with a 6 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 200 fpm, oven temperature was 105° C. (220° F.) and a single coating pass was applied. The resultant roll was then passed through the equipment using the same procedure for a second coating treatment on the same previously coated surface. The coating composition was applied with an approximate total coat weight of 12 mg/sqin. The resultant coated roll was converted into 20″×25″ sheets, grain long.

### Example 22

Coating composition Wikoff 1124, manufactured and supplied by Wikoff Industries was applied to 300 ft of 2 mil Klockner ZE84 pvc sheet using a flexographic or gravure coating method. A single coating station was fixtured with a 6 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 200 fpm, oven temperature was 105° C. (220° F.) and a single coating pass was applied. The coating composition was applied with an approximate coat weight of 6.1 mg/sqin. The resultant coated roll was converted into 20″×25″ sheets, grain long.

### Example 23

Coating composition Wikoff 1124, manufactured and supplied by Wikoff Industries was applied to 300 ft of 2 mil Klockner ZE84 pvc sheet using a flexographic or gravure coating method. A single coating station was fixtured with a 6 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 200 fpm, oven temperature was 105° C. (220° F.) and a single coating pass was applied. The resultant roll was then passed through the equipment using the same procedure for a second coating treatment on the same previously coated surface. The coating composition was applied with an approximate total coat weight of 12 mg/sqin. The resultant coated roll was converted into 20″×25″ sheets, grain long.

### Example 24

The 2 mil coated pvc sheet prepared as described in Example 20 was fabricated into cards using the following procedure. One coated Teslin sheet was placed on top of one 20-inch×25-inch sheet of 0.10-inch polyvinylchloride (PVC), supplied by Empire Plastics. The PVC sheet was cut in the grain long direction. Below the PVC:ply was a second ply of 20-inch×25-inch×10 mil PVC, cut grain short. Below the 10 mil PVC grain short ply was the coated 20-inch×25-inch×2 mil PVC sheet cut grain long, positioned with the coated surface facing away from the adjacent 10 mil pvc ply. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261° F. Then while still under press, the platens were cooled long enough to allow the same center plys to reach 100° F. After being removed from the press, all twelve composite sheets were removed from the book. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards demonstrated non-blocking behavior and required slip performance.

Friction Force Test Method

A card was fixed to a smooth flat base.

A second card was placed on top of the base card, with an offset of ½-inch over the long edge.

The second card was attached to a force gauge through a cable and pulley system. The force gauge was fixed to the travel arm of an instron.

A symmetrical weight was placed on the second card with the back edge of the weight centered and flush with the trailing edge of the second card.

The card pair was staged one (1) minute prior to pulling.

The top card was slid over the bottom card approximately 1.5-inch and the maximum pull force measured on the force gauge was recorded.

The procedure was repeated five (5) times, each time with a different card pair.

The average, standard deviation and % coefficient of variation of all six measurements were calculated and reported.

Card Slip Performance

| Friction | | | | | |
|---|---|---|---|---|---|
| Force | | 4890/1 | 4890/2 | 1124/1 | 1124/2 |
| Measurements | Uncoated | pass | passes | pass | passes |
| 1 kg load | 1.33 | 1.105 | 0.984 | 1.058 | 1.221 |
| results (lb.) | | | | | |
| Std dev. | 0.073 | 0.192 | 0.068 | 0.062 | 0.108 |
| % COV | 5.5 | 17.4 | 6.9 | 5.9 | 8.8 |
| 200 g load | 0.284 | 0.179 | 0.144 | 0.192 | 0.188 |
| results (lb.) | | | | | |
| Std. Dev. | 0.036 | 0.027 | 0.014 | 0.025 | 0.019 |
| % COV | 12.6 | 15.1 | 9.79 | 13.1 | 10.3 |

### Example 25

Coating composition Wikoff SCW 4890, manufactured and supplied by Wikoff Industries was applied to 14,000 ft of 2 mil Klockner ZE84 pvc sheet using a flexographic or gravure coating method. A single coating station was fixtured with a 6 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 200 fpm, oven temperature was 105° C. (220° F.) and a single coating pass was applied. A gentle curtain of air was directed towards the continuous coated sheet just prior to the wind-up station to eliminate folds and wringles. The coating composition was applied with an approximate coat weight of 6.1 mg/sqin. The resultant coated roll was converted into 20″×25″ sheets, grain long.

### Example 26

The 2 mil coated pvc sheet prepared as described in Example 25 was fabricated into cards using the following procedure. One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was the coated 20-inch×25-inch×2 mil PVC sheet cut grain long, positioned with the coated surface facing away from the adjacent 10 mil pvc ply. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261° F. Then while still under press, the platens were cooled long enough to allow the same center plys to reach 100° F. After being removed from the press, all twelve composite sheets were removed from the book. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards demonstrated non-blocking behavior and required slip performance.

Card Slip Performance

| Friction Force | |
|---|---|
| Measurements | Production Scale Sample 4890/6 bcm/1 pass |
| 1 kg Load Result (lb.) | 0.881 |
| Std dev. | 0.106 |
| % COV | 11.99 |

### Example 27

Coating composition Wikoff SCW 4890, manufactured and supplied by Wikoff Industries was applied to a 2 mil Klockner ZE84 pvc substrate sold by Klockner corp. A 8.5″×11″ sheet was placed on a 15″×20″×20 mil backing sheet. A #9 metering bar was placed 1-2 inches above the top of the pvc sheet, parallel to the top edge. A 10-20 ml quantity of coating was drawn into a disposable plastic syringe. The coating was deposited as a bead strip (approximately ⅛ inches wide) directly next to and touching the Metering Bar. The bar was drawn completely across the sheet of pvc at a continuous/constant rate. The Resultant wet sheet was placed in a forced air oven, secured and dried at 95° C. for 2 minutes. The sheet was then ready to be laminated and tested.

### Example 28

Coating composition Wikoff SCW 4890, manufactured and supplied by Wikoff Industries was applied to a 2 mil Klockner ZE84 pvc substrate sold by Klockner corp. A 8.5″×11″ sheet was placed on a 15″×20″×20 mil backing sheet. A #0 metering bar was placed 1-2 inches above the top of the pvc sheet, parallel to the top edge. A 10-20 ml quantity of coating was drawn into a disposable plastic syringe. The coating was deposited as a bead strip (approximately ⅛ inches wide) directly next to and touching the Metering Bar. The bar was drawn completely across the sheet of pvc at a continuous/constant rate. The Resultant wet sheet was placed in a forced air oven, secured and dried at 95° C. for 2 minutes. The sheet was then ready to be laminated and tested.

### Example 29

The 2 mil coated pvc sheet prepared as described in Example 27 was fabricated into cards using the following procedure. One coated Teslin sheet was placed on top of one 8.5-inch×11-inch sheet of 0.10-inch polyvinylchloride (PVC), supplied by Empire Plastics. The PVC sheet was cut in the grain long direction. Below the PVC ply was a second ply of 8.5-inch×11-inch×10 mil PVC, cut grain short. Below the 10 mil PVC grain short ply was the coated 8.5-inch×11-inch×2 mil PVC sheet cut grain long, positioned with the coated surface facing away from the adjacent 10 mil pvc ply. A sheet 12-inch×12-inch of 2-mil clear polyester was placed over the Teslin sheet to act as a release liner. This construction was placed between two 12″×12″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated two more times so that four pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a phi laminating press, preheated to 300° F. The composite construction was compression laminated at a pressure of 203 psi. The entire book was held under this condition for 30 minutes. Then while still under press, power to the platens was turned off long enough to allow the center plys of the book to reach 100° F. After being removed from the press, all four composite sheets were removed from the book. All four finished composite sheets had good integrity; any attempt to delaminate destroyed the Teslin layer, which demonstrated a good adhesive and seamless bond between the Teslin and the PVC. IS07910 ID-1 cards were die cut from the each composite sheets. The finished cards from each composite sheet had good integrity and good lat flat. The resultant cards demonstrated non-blocking behavior and required slip performance.

### Example 30

The 2 mil coated pvc sheet prepared as described in Example 28 was fabricated into cards using the following procedure. One coated Teslin sheet was placed on top of one 8.5-inch×11-inch sheet of 0.10-inch polyvinylchloride (PVC), supplied by Empire Plastics. The PVC sheet was cut in the grain long direction. Below the PVC ply was a second ply of 8.5-inch×11-inch×10 mil PVC, cut grain short. Below the 10 mil PVC grain short ply was the coated 8.5-inch×11-inch×2 mil PVC sheet cut grain long, positioned with the coated surface facing away from the adjacent 10 mil pvc ply. A sheet 12-inch×12-inch of 2-mil clear polyester was placed over the Teslin sheet to act as a release liner. This construction was placed between two 12″×12″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated two more times so that four pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a phi laminating press, preheated to 300° F. The composite construction was compression laminated at a pressure of 203 psi. The entire book was held under this condition for 30 minutes. Then while still under press, power to the platens was turned off long enough to allow the center plys of the book to reach 100° F. After being removed from the press, all four composite sheets were removed from the book. All four finished composite sheets had good integrity; any attempt to delaminate destroyed the Teslin layer, which demonstrated a good adhesive and seamless bond between the Teslin and the PVC. IS07910 ID-1 cards were die cut from the each composite sheets. The finished cards from each composite sheet had good integrity and good lat flat. The resultant cards demonstrated non-blocking behavior and required slip performance.

Card Slip Performance

| Friction | | | |
|---|---|---|---|
| Force | | | |
| Measurements | Uncoated | 4890/9 rod | 4890/0 rod |
| 1 kg load | 2.12 | 0.917 | 0.770 |
| results (lb.) | | | |
| Std dev. | 0.44 | 0.114 | 0.085 |
| % COV | 20.7 | 12.4 | 11.0 |

### Example 31

Coating composition Wikoff SCW 4890, manufactured and supplied by Wikoff Industries was applied to 150 ft of 2 mil Klockner ZE84 pvc sheet using a flexographic or gravure coating method. A single coating station was fixtured with a 6 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 200 fpm, oven temperature was 105° C. (220° F.) and a single coating pass was applied. A gentle curtain of air was directed towards the continuous coated sheet just prior to the wind-up station to eliminate folds

and wringles. The coating composition was applied with an approximate coat weight of 6.1 mg/sqin. The resultant coated roll was converted into 20″×25″ sheets, grain long.

### Example 32

Coating composition Wikoff SCW 4890, manufactured and supplied by Wikoff Industries was applied to 150 ft of 2 mil Klockner ZE84 pvc sheet using a flexographic or gravure coating method. A single coating station was fixtured with a 5 bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 300 fpm, oven temperature was 105° C. (220° F.) and a single coating pass was applied. A gentle curtain of air was directed towards the continuous coated sheet just prior to the wind-up station to eliminate folds and wringles. The coating composition was applied with an approximate coat weight of 5 mg/sqin. The resultant coated roll was converted into 20″×25″ sheets, grain long.

### Example 33

A coating composition consisting of 75 parts Wikoff 1124 and 25 parts Wikoff SCW 4890, was applied to 150 ft of 2 mil Klockner ZE84 pvc sheet using a flexographic or gravure coating method. A single coating station was fixtured with a 5bcm anilox roll and non-textured rubber application roll. The coating feed chamber was supplied from a coating holding tank and pump. Continuous roll stock was threaded through the equipment so that the coated sheet passed through a drying oven, with the coated surface facing the hot air source. The line speed was 300 fpm, oven temperature was 105° C. (220° F.) and a single coating pass was applied. A gentle curtain of air was directed towards the continuous coated sheet just prior to the wind-up station to eliminate folds and wringles. The coating composition was applied with an approximate coat weight of 5 mg/sqin. The resultant coated roll was converted into 20″×25″ sheets, grain long.

### Example 34

The 2 mil coated pvc sheet prepared as described in Example 31 was fabricated into cards using the following procedure. One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was the coated 20-inch×25-inch×2 mil PVC sheet cut grain long, positioned with the coated surface facing away from the adjacent 10 mil pvc ply. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261° F. Then while still under press, the platens were cooled long enough to allow the same center plys to reach 100° F. After being removed from the press, all twelve composite sheets were removed from the book. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards demonstrated non-blocking behavior and required slip performance. Any attempt to delaminate destroyed the Teslin layer, which demonstrated a good adhesive and seamless bond between the Teslin and the PVC.

### Example 35

The 2 mil coated pvc sheet prepared as described in Example 32 was fabricated into cards using the following procedure. One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was the coated 20-inch×25-inch×2 mil PVC sheet cut grain long, positioned with the coated surface facing away from the adjacent 10 mil pvc ply. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261 F. Then while still under press, the platens were cooled long enough to allow the same center plys to reach 100° F. After being removed from the press, all twelve composite sheets were removed from the book. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards demonstrated non-blocking behavior and required slip performance. Any attempt to delaminate destroyed the Teslin layer, which demonstrated a good adhesive and seamless bond between the Teslin and the PVC.

### Example 36

The 2 mil coated pvc sheet prepared as described in example Example 33 was fabricated into cards using the following procedure. One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was the coated 20-inch×25-inch×2 mil PVC sheet cut grain long, positioned with the coated surface facing away from the adjacent 10 mil pvc ply. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261° F. Then while still under press, the platens were cooled long enough to allow the same center plys to reach 100° F. After being removed from the press, all twelve composite sheets were removed from the book. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards demonstrated non-blocking behavior and required slip performance. Any attempt to delaminate destroyed the Teslin layer, which demonstrated a good adhesive and seamless bond between the Teslin and the PVC.

### Example 37

One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was a 20-inch×25-inch×2 mil PVC sheet of Klockner ZE84 cut grain long. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261F. Then while still under press, the platens were cooled long enough to allow the same center plys to reach 100° F. After being removed from the press, all twelve composite sheets were removed from the book. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards did not demonstrated non-blocking behavior and required slip performance. Any attempt to delaminate destroyed the Teslin layer, which demonstrated a good adhesive and seamless bond between the Teslin and the PVC.

### Example 38

One coated Teslin sheet was placed on top of one 20-inch×25-inch sheet of 0.10-inch polyvinylchloride (PVC), supplied by Empire Plastics. The PVC sheet was cut in the grain long direction. Below the PVC ply was a second ply of 20-inch×25-inch×10 mil PVC, cut grain short. Below the 10 mil PVC grain short ply was a 20-inch×25-inch×2 mil PVC sheet of Klockner ZE84 cut grain long. A sheet 21-inch×26-inch of 2-mil clear polyester was placed over the Teslin sheet to act as a release liner. This construction was placed between two 21″×26″×30 mil polished stainless steel metal plate. An identical polyester/treated Teslin sheet/PVC/PVC/PVC lay-up was placed on top of a stainless plate from the existing construction. A polished metal plate was placed over the exposed polyester release liner. The pattern was repeated ten more times so that twelve pre-pressed multi-layer plys existed in the stack. The resultant stack was placed between buffer pads. The buffer pads are a combination polyamide fiber and mechanical rubber, manufactured and supplied by Yamauchi Corporation, designed to more uniformally distribute temperature and press during thermal lamination. The resultant stack plus buffer pads was then placed between two slightly larger 125 mil un-polished non-corrosive metal plates. This entire construction, referred to as a book, was placed in a TMP laminating press, preheated to 300° F. The composite construction was compression laminated at a pressure of 203 psi. The entire book was held under this condition until the middle ply's of the book reached a temperature of 261F. Then while still under press, the platens were cooled long enough to allow the same center plys to reach 100° F. After being removed from the press, all twelve composite sheets were removed from the book. All twelve composite sheets were topically treated with static guard on the pvc surface. All twelve finished composite sheets had good integrity; any attempt to delaminate destroyed the Teslin layer, which demonstrated a good adhesive and seamless bond between the Teslin and the PVC. IS07910 ID-1 cards were die cut from the each of the 20-inch×25-inch×30.5 mil composite sheets. The finished cards from each composite sheet had good integrity and good lat flat. The resultant cards demonstrated non-blocking behavior and required slip performance. These cards did, however, block when placed in a 100 card stack following exposure to 24 hours, 85% RH, 55C, under a 1 kg. load. Any attempt to delaminate destroyed the Teslin layer, which demonstrated a good adhesive and seamless bond between the Teslin and the PVC.

Lamination Plate Build-up & Friction Force vs. PVC Surface Treatment

| | | | Friction | |
|---|---|---|---|---|
| | | | Force | |
| | | Initial | following | |
| | | 1 kg | 85% RH/ | Build- |
| | 2 mil PVC surface | Friction | 55 C/ | up/ |
| | treatment (Anilox | Force | 1 kg/24 | Lamination |
| Sample ID | Roll/Chemistry) | (lb.) | hrs (lb.) | Cycles |
| Uncoated | Not Applicable | >2.0 | Cards | No residue/ |
| | | | Blocked | build-up |
| 8181-92-01 | 6 bcm/solid | 0.728 | 0.851 | Heavy/ |
| | roll/4890/1 pass | | | 2 cycles |
| 8181-92-02 | 5 bcm/solid | 0.669 | 0.859 | Slight/ |
| | roll/4890/1 pass | | | 3 cycles |
| 8181-92-04 | 5 bcm/solid roll/75/25- | 0.888 | 0.938 | Very Slight/ |
| | 1124/4890 blend/ | | | 3 cycles |
| | 1 pass | | | |
| Lot #24 | Laminates topically | 0.721 | Cards | No residue/ |
| | treated with DMDTAC | | blocked | build-up |

Teslin Coating Method (25 Gallon Mix)

| Ingredients | Amounts |
|---|---|
| CinFix RDF | 13.46 kg |
| Deionized Water | 24.98 kg |
| PPG WC-71-2134 | 12.24 kg |
| Deionized Water | 16.74 kg |
| Witcobond W240 | 12.17 kg |
| Deionized Water | 16.65 kg |

Mix Procedure
Added specified amount of CinFix RFD to the main mix
container and stirred.
Added specified amount of DI water to the CinFix RFD
and stirred for 10 minutes prior to the next premix
addition. Continued to stir throughout the entire mix
procedure.
Added specified amount of PPG WC-71-2134 to a premix
container and stirred.
Added specified amount of DI water to the PPG
WC-71-2134 and stirred for 10 minutes.
Added PPG WC-71-2134 premix to the main mix
container.
Added specified amount of Witcobond W240 to a premix
container and stirred.
Added specified amount of DI water to the PPG
WC-71-2134 and stirred for 10 minutes.
Added Witcobond W240 premix to the main mix
container.
Stirred the final mix for 15 minutes.
Measured/Monitored solids, pH and viscosity and made
any necessary adjustments.

Coating Composition Given in a Descriptive Format:

| | |
|---|---|
| Coating Description: | 40 active parts CinFix RDF |
| | 30 active parts PPG WC-71-2134 |
| | 30 active parts Witcobond W240 |
| | 12.5% Total Mix Solids |

### Example 40

A coating composition of the present invention was prepared by first diluting of an aqueous 35.7% polydiallyldimethylammonium chloride (polyDADMAC) solution sold under the trade name CinFix RDF available from Stockhausen GmbH & Co. K G, Krefeld, Germany to 12.5% with deionized water in a stainless steel or polyethylene mix vessel under mild agitation. Mild agitation defined by a medium pitch three lobed mixing head, the system at a mix-head to mix vessel diameter ratio of 1 to 3 and the mix-head spinning at 600-1000 rpm and appropriately positioned. In a separate mix container, a 27.3% aqueous cationic acrylic solution sold under the name WC-71-2143 available from PPG Industries, Inc. is diluted with deionized water to 12.5% and added to the main mix vessel containing pre-diluted CinFix RDF. In a separate mix container, a 29.6% aqueous cationic polyurethane dispersion sold under the trade name Witcobond W240 available from Crompton Corporation is diluted with deionized water to 12.5% and added to the main mix vessel containing the CinFix RDF and PPG WC-71-2143 mixture. The resultant coating composition is stirred for 15 minutes. The resultant pH was 5.5+/−0.5. The total solids of the composition was 12.5%. It had a viscosity of 17 seconds measured using a #2 Zahn cup at 20° C.

### Example 41

Coating composition prepared as in Example 40 (Improved coating for card stock Teslin, -09 coating, 12.5% solids) and was applied to a 500 ft roll of 10 mil Teslin SP1000 microporous substrate by a flexographic or gravure coating method. In this coating method, a line consisting of two coating stations, each with a forced air drying oven was used. Each coating station consists of a coating feed chamber, anilox roll and rubber application roll. The coating feed chambers were supplied from a coating holding tank and pump. Continuous roll stock was threaded through the equipment so that both side were coated during a single pass. Each coating station was fitted with a 5BCM anilox roll. Successive passes were arranged so that both sheet surfaces contacted the other rubber roll at least once. A total of 4 coating passes were applied. The line speed was 240 fpm and oven temperatures were set at 105° C. (220° F.). The coating composition was applied with an approximate coat weight of 0.81 g/m² (total front and back). The resultant roll was converted into 20″×25″ sheets, grain long.

In the claims:

1. A multilayer article comprising a microporous substrate at least partially connected to a substantially nonporous material, said microporous substrate at least partially coated with a substantially water-resistant coating composition, said coating composition comprising a stable dispersion of:
(a) an aqueous polyurethane dispersion; and
(b) a cationic nitrogen-containing polymeric dye fixative material at least partially dissolved in an aqueous medium.

2. The multilayer article of claim 1 wherein said microporous substrate comprises:
(a) a polyolefin;
(b) a particulate silica material; and
(c) a porosity wherein the pores constitute at least 35 percent by volume of the microporous substrate.

3. The multilayer article of claim 2 wherein said polyolefin is chosen from polyethylene, polypropylene, and mixtures thereof.

4. The multilayer article of claim 3 wherein said polyethylene comprises an essentially linear high molecular weight polyethylene having an intrinsic viscosity of at least 10 deciliters/gram, and said polypropylene comprises an essentially linear high molecular weight polypropylene having an intrinsic viscosity of at least 5 deciliters/gram.

5. The multilayer article of claim 2 wherein said particulate silica material comprises precipitated silica.

6. The multilayer article of claim 2 wherein said particulate silica material comprises from 50 to 90 percent by weight of said microporous substrate.

7. The multilayer article of claim 2 wherein said pores comprise from 35 percent to 95 percent by volume of said microporous substrate.

8. The multilayer article of claim 1 wherein said aqueous polyurethane dispersion is chosen from aqueous dispersions of anionic polyurethanes, cationic polyurethanes, nonionic polyurethanes and mixtures thereof.

9. The multilayer article of claim 8 wherein said anionic polyurethane is chosen from aromatic polyether polyurethanes, aliphatic polyether polyurethanes, aromatic polyester polyurethanes, aliphatic polyester polyurethanes, aromatic polycaprolactam polyurethanes, aliphatic polycaprolactam polyurethanes, and mixtures thereof.

10. The multilayer article of claim 1 wherein said polymeric dye fixative material comprises a polymer comprising monomer residues derived from one or more nitrogen-containing monomers chosen from: 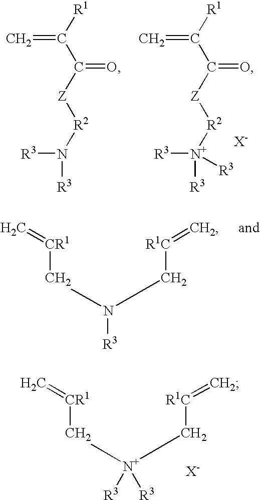
where R¹ represents independently for each occurrence in each structure, H or C₁ to C₃ aliphatic; R² represents independently for each structure a divalent linking group selected from C₂ to C₂₀ aliphatic hydrocarbon, polyethylene glycol and polypropylene glycol; R³ represents independently for each occurrence in each structure H, C₁ to C₂₂ aliphatic hydrocarbon or a residue from the reaction of the nitrogen with epichlorohydrin; Z is selected from —O— or —NR⁴—, where R⁴ is H or CH₃; and X is a halide or methylsulfate.

11. The multilayer article of claim 1 wherein said coating composition has a pH less than 7.

12. The multilayer article of claim 1 wherein said microporous substrate comprises an ink jet recordable substrate.

13. The multilayer article of claim 1 wherein said microporous substrate at least partially coated with said substantially water-resistant coating composition has a thickness of at least 0.1 mils.

14. The multilayer article of claim 1 wherein said substantially nonporous material is chosen from substantially nonporous thermoplastic polymers, substantially nonporous metalized thermoplastic polymers, substantially nonporous thermoset polymers, substantially nonporous elastomerics, substantially nonporous metals and mixtures thereof.

15. The multilayer article of claim 14 wherein said thermoplastic polymers are chosen from polyethylene, high density polyethylene, low density polyethylene, polypropylene, poly(vinyl chloride), saran, polystyrene, high impact polystyrene, nylons, polyesters, copolymers of ethylene and acrylic acid, copolymers of ethylene and methacrylic acid, and mixtures thereof.

16. A multilayer article of claim 14 wherein said thermoset polymers are chosen from thermoset phenol-formaldehyde resin, thermoset melamine-formaldehyde resin, and mixtures thereof.

17. The multilayer article of claim 14 wherein said elastomers are chosen from natural rubber, neoprene, styrene-butadiene rubber, acrylonitrile-butadiene-styrene rubber, elastomeric polyurethanes, elastomeric copolymers of ethylene and propylene, and mixtures thereof.

18. The multilayer article of claim 14 wherein said metals are chosen from iron, steel, copper, brass, bronze, chromium, zinc, die metal, aluminum, cadmium and mixtures thereof.

19. The multilayer article of claim 1 wherein said microporous substrate is at least partially connected to said substantially nonporous material by a fusion bond in the absence of an adhesive.

20. The multilayer article of claim 1 wherein said microporous substrate is at least partially connected to said substantially nonporous material by an adhesive.

21. The multilayer article of claim 20 wherein said adhesive polyvinyl acetate, starches, gums, polyvinyl alcohol, animal glues, acrylics, epoxies, polyethylene-containing adhesives, rubber-containing adhesives, and mixtures thereof.

22. A method for producing a multilayer article comprising the steps of:
(a) providing a microporous substrate having a top surface and a bottom surface;
(b) providing a substantially water-resistant coating composition comprising a stable dispersion of:
a. an aqueous polyurethane dispersion; and
b. a cationic nitrogen-containing polymeric dye fixative material at least partially dissolved in an aqueous medium;
(c) at least partially applying said coating composition to at least one surface of said microporous substrate;
(d) at least partially connecting said microporous substrate of (c) to a substantially nonporous material.

23. The method of claim 22 wherein said microporous substrate comprises:
(a) a polyolefin;
(b) a particulate silica material; and
a porosity wherein the pores constitute at least 35 percent by volume of the microporous substrate.

24. The method of claim 23 wherein said polyolefin is chosen from polyethylene, polypropylene, and mixtures thereof.

25. The method of claim 24 wherein said polyethylene comprises an essentially linear high molecular weight polyethylene having an intrinsic viscosity of at least 10 deciliters/gram, and said polypropylene comprises an essentially linear high molecular weight polypropylene having an intrinsic viscosity of at least 5 deciliters/gram.

26. The method of claim 23 wherein said particulate silica material comprises precipitated silica.

27. The method of claim 22 wherein said microporous substrate comprises an ink jet recordable substrate.

28. The method of claim 22 wherein said aqueous polyurethane dispersion is chosen from aqueous dispersions of anionic polyurethanes, cationic polyurethanes, nonionic polyurethanes and mixtures thereof.

29. The method of claim 22 wherein said substantially nonporous material is chosen from substantially nonporous thermoplastic polymers, substantially nonporous metalized thermoplastic polymers, substantially nonporous thermoset polymers, substantially nonporous elastomerics, substantially nonporous metals and mixtures thereof.

30. The method of claim 29 wherein said substantially nonporous material comprises polyvinyl chloride.

31. The method of claim 22 wherein said microporous substrate is at least partially connected to said substantially nonporous material by a fusion bond in the absence of an adhesive.

32. The method of claim 22 wherein said microporous substrate is at least partially connected to said substantially nonporous material by an adhesive.

33. The method of claim 32 wherein said adhesive polyvinyl acetate, starches, gums, polyvinyl alcohol, animal glues, acrylics, epoxies, polyethylene-containing adhesives, rubber-containing adhesives, and mixtures thereof.

34. A multilayer article comprising a microporous substrate at least partially connected to a substantially nonporous material, said microporous substrate at least partially coated with a substantially water-resistant coating composition, and at least one of said microporous substrate and substantially nonporous material at least partially coated with a friction-reducing coating composition.

35. The multilayer article of claim 34 wherein said substantially water-resistant coating composition comprises:
(a) an aqueous polyurethane dispersion; and
(b) a cationic nitrogen-containing polymeric dye fixative material at least partially dissolved in an aqueous medium.

36. The multilayer article of claim 34 wherein said friction-reducing coating composition comprises a lubricant and a resin.

37. The multilayer article of claim 36 wherein said lubricant comprises polysiloxane.

38. The multilayer article of claim 36 wherein said resin comprises styrene acrylic polymer.

39. A method for producing a multilayer article comprising the steps of:
(a) providing a microporous substrate having a top surface and a bottom surface;
(b) providing a substantially water-resistant coating composition comprising a stable dispersion of:
(i) an aqueous polyurethane dispersion; and
(ii) a cationic nitrogen-containing polymeric dye fixative material at least partially dissolved in an aqueous medium;
(c) at least partially applying said coating composition to at least one surface of said microporous substrate;
(d) at least partially connecting said microporous substrate of (c) to a substantially nonporous material having a top surface and a bottom surface;
(e) providing a friction-reducing coating composition; and
(f) at least partially applying said friction-reducing coating composition to at least one surface of at least one of said microporous substrate and said substantially nonporous material.

40. A multilayer article comprising an ink jet recordable substrate, at least one substantially nonporous material and a magnetizable material.

41. The multilayer article of claim 40 wherein said magnetizable material is an oxide material.

42. The multilayer article of claim 41 wherein said oxide material is selected from ferrous oxide, iron oxide, and mixtures thereof.

43. The multilayer article of claim 40 wherein said magnetizable material is in a slurry.

44. The multilayer article of claim 40 wherein said magnetizable material has a coercivity of from 200 to 5000.

45. The multilayer article of claim 40 wherein said magnetizable material is at least partially connected to at least one material selected from a protective material, a carrier material or an adhesive material.

46. The multilayer article of claim 45 wherein said protective material is selected from polyethylene teraphthalate, polyester and combinations thereof.

47. The multilayer article of claim 45 wherein said carrier material is selected from polyethylene teraphthalate, polyester and combinations thereof.

48. The multilayer article of claim 45 wherein said adhesive material is selected from polyvinyl acetate, starches, gums, polyvinyl alcohol, animal glues, acrylics, epoxies, polyethylene-containing adhesives, and rubber-containing adhesives.

49. The multilayer article of claim 45 wherein said protective material is at least partially connected to said magnitizable material, said magnetizable material is at least partially connected to said carrier material, and said carrier material is at least partially connected to said adhesive material.

50. The multilayer article of claim 40 wherein said magnetizable material is at least partially connected to said ink jet recordable substrate.

51. The multilayer article of claim 40 wherein said magnetizable material is at least partially connected to said substantially nonporous material.

52. The multilayer article of claim 40 wherein said ink jet recordable substrate is a microporous substrate.

53. The multilayer article of claim 40 wherein said substantially nonporous material is polyvinyl chloride.

54. The multilayer article of claim 40 wherein said magnetizable material is at least partially coated with a substantially water-resistant coating composition.

55. The multilayer article of claim 54 wherein said substantially water-resistant coating composition is the coating composition of claim 1.

56. The multilayer article of claim 54 wherein at least one surface of said ink jet recordable substrate is at least partially coated with a substantially water-resistant coating composition.

57. The multilayer article of claim 54 wherein at least one surface of said substantially nonporous material is at least partially coated with a substantially water-resistant coating composition.

58. The multilayer article of claim 40 wherein at least one surface of said magnetizable material is at least partially coated with a friction reducing coating composition.

59. The multilayer article of claim 58 wherein said friction reducing coating composition further comprises at least one lubricant and at least one resin.

60. The multilayer article of claim 58 wherein said ink jet recordable substrate is at least partially coated with a friction reducing coating composition.

61. The multilayer article of claim 58 wherein said substantially nonporous material is at least partially coated with a friction reducing coating composition.

62. The multilayer article of claim 40 further comprising a release liner at least partially connected to at least one surface of said multlayer article.

63. A multilayer article comprising a microporous substrate at least partially connected to a first substantially nonporous material; said first substantially nonporous material at least partially connected to a second substantially nonporous material; said second substantially nonporous material at least partially connected to a third substantially nonporous material; said third substantially nonporous material comprising a magnetizable material.

64. A multlayer article comprising a magnetizable material at least partially connected to an adhesive material and said adhesive material at least partially connected to a substantially nonporous material.

65. A multilayer article comprising a magnetizable material at least partially connected to an adhesive material and said adhesive material at least partially connected to an ink jet recordable material.

66. A multilayer article comprising a magnetizable material, an ink jet recordable substrate and a substantially nonporous material wherein said ink jet recordable substrate is at least partially coated with a substantially water-resistant coating composition, and at least one of said ink jet recordable substrate and substantially nonporous material is at least partially coated with a friction-reducing coating composition.

67. A multilayer article comprising an ink jet recordable substrate, at least one substantially nonporous material and a data transmittance/storage device.

68. The multilayer article of claim 67 wherein said data transmittance/storage device comprises a carrier material.

69. The multilayer article of claim 68 wherein said carrier material is polyvinylchloride.

70. The multilayer article of claim 67 wherein said data transmittance/storage device comprises a barrier material.

71. The multilayer article of claim 70 wherein said data transmittance/storage device can be at least partially connected to said barrier material using an adhesive material.

72. The multilayer article of claim 70 wherein at least one surface of said barrier material is at least partially coated with a coating composition selected from a substantially water-resistant coating composition, or a friction reducing coating composition or a combination thereof.

73. The multilayer article of claim 70 wherein said barrier material comprises a substantially nonporous material.
